(19) United States
(12) Patent Application Publication
(10) Pub. No.: US 2014/0130182 A1
(43) Pub. Date: May 8, 2014

(54) Controlled Grant Of Access To Media Content

(71) Applicant: GenesisMedia LLC, New York, NY (US)

(72) Inventors: Mark Adam Yackanich, Hoboken, NJ (US); Joshua Paul Feuer, New York, NY (US); Philip Anthony Palmroth, Tarrytown, NY (US); Toby Alexander Dingemans, New York, NY (US)

(73) Assignee: GenesisMedia LLC, New York, NY (US)

(21) Appl. No.: 14/069,810

(22) Filed: Nov. 1, 2013

Related U.S. Application Data
(60) Provisional application No. 61/721,627, filed on Nov. 2, 2012.

(51) Int. Cl. G06F 21/60

(52) U.S. Cl. CPC G06F 21/60
USPC 726/27

(57) ABSTRACT

A computer implemented method and system for controlling grant of access to first media content (FMC) is provided. A content access management application (CAMA) dynamically analyzes user characteristics on detection of a user attempt to access the FMC on a content display interface. The CAMA receives decision criteria, for example, preset rules, user segments, etc., via a criteria reception interface, dynamically creates one or more dynamic media content objects including a locking media content object and a non-locking media content object, and dynamically inserts the dynamic media content objects into one or more sections of the content display interface based on the analyzed user characteristics and one or more of the decision criteria. Each dynamic media content object either restricts access to the FMC displayed on the content display interface until an access condition is met or grants access to the FMC while displaying second media content, for example, advertisements.

### CROSS REFERENCE TO RELATED APPLICATIONS

This application claims priority to and the benefit of provisional patent application No. 61/721,627 titled “Unlocking Of Locked Media Content”, filed in the United States Patent and Trademark Office on Nov. 2, 2012.

The application also claims the benefit of the following patent applications:
1. Non-provisional patent application Ser. No. 12/485,955, now U.S. Pat. No. 8,561,097, titled “Multimedia Content Viewing Confirmation”, filed in the United States Patent and Trademark Office on Jun. 17, 2009.
2. Continuation-in-part patent application Ser. No. 12/544,233 titled “Multimedia Content Viewing Confirmation”, filed in the United States Patent and Trademark Office on Aug. 20, 2009.
3. Continuation-in-part patent application Ser. No. 12/822,526, now U.S. Pat. No. 8,484,563, titled “View Confirmation For On-demand Multimedia Content”, filed in the United States Patent and Trademark Office on Jun. 24, 2010.
4. Continuation-in-part patent application Ser. No. 13/216,256 titled “View Confirmation Using A Challenge”, filed in the United States Patent and Trademark Office on Aug. 24, 2011.

The specifications of the above referenced patent applications are incorporated herein by reference in their entirety.

### BACKGROUND

Online advertising, also referred to as internet advertising, is used to deliver custom media content, for example, promotional marketing messages or advertisements to consumers or users through a communication network, for example, the internet. Online advertising comprises, for example, marketing via electronic mail (email), search engine marketing, social media marketing, display advertising, mobile advertising, video advertising, etc. Online video advertising is growing rapidly as online video advertising provides an effective method of engaging users when compared to conventional direct advertising methods, for example, via television. Many websites contain advertisement placements which are areas or sections of web pages configured for displaying advertisements. Typically, advertisement placements are static, that is, they are hard coded on a web page such that an advertisement is visible to each user on the web page. Advertisers demand more premium video inventory, greater transparency, better performance, and audience targeting. Advertisers often search for premium video inventory, but premium video inventory is scarce because video advertisements are typically displayed only before online video content, which is more expensive to produce and distribute at scale than other forms of online media content such as textual articles, photo galleries, etc.

Furthermore, premium online media content owners who are not focused on producing and distributing video content, for example, newspapers, magazines, radio station websites, etc., are struggling to generate revenue from low value display advertisement products which typically generate less revenue than online video advertisements. Some media content owners also charge users for providing access to their content by requiring payment of subscription fees from the users prior to providing the users with partial or complete access to the content on the media content owner's hosting platform, for example, a website. Many potential users may be unwilling to pay the subscription fees for obtaining access to the content and therefore stop visiting the media content owner's or publisher's website resulting in lost revenue opportunities. Few websites generate a subscription rate higher than about 5% of visitors. These media content owners are actively seeking new ways to conduct their businesses, including finding new sources of revenue, engaging loyal users more effectively, and generating revenue via portable devices such as mobile phones and tablet devices.

Currently, owners of multimedia content such as video content and audio content depend on “forced view” models to generate revenue where advertisements are shown to users either before or during playback of multimedia content segments selected by the users. An example of a forced view model is a video pre-roll, where a video advertisement is shown to a user before a selected video content segment. Another example of a forced view model is a video mid-roll, where a video advertisement is shown to a user in the middle of a selected video content segment. These forced view models effectively gate access to the selected content segments in such a way that the user must access advertisements to access the selected content segments. These forced view models do not require payment of any subscription fees and hence are more effective in engaging the users and generating revenue. However, the forced view models currently available are applicable only to multimedia content, for example, video content and audio content, where a single content segment must be presented to the user over a period of time determined by the length of the content segment. These forced view models do not provide an option to gate static content such as web pages, textual articles, photographs, etc., where the content can be displayed to the user all at once.

Some forced view models allow multimedia content owners to control access to their content by specifying access rules and parameters. For example, some forced view models allow multimedia content owners to specify when a video advertisement should be shown to the user during playback of a video content segment selected by the user. These rules may leverage information about the user such as subscription status of the user as well as information about the selected content segment such as length of the content segment. In another example, a forced view model may allow a multimedia content owner to specify how many video advertisements are to be displayed during playback of a video content segment selected by a user who is a paid subscriber of the multimedia content owner's website. Furthermore, some forced view models use sophisticated rules and parameters to select advertisements to be shown during playback of gated multimedia content segments. However, these forced view models do not compute or generate optimal rules to control access to media content based on decision criteria set by the media content owner, user characteristics, and other decision criteria.

Hence, there is a long felt but unresolved need for a computer implemented method and system that controls grant of access of media content to users based on decision criteria set by the media content owner, user characteristics, and other decision criteria. Furthermore, there is a need for a computer implemented method and system that enables the users to engage with media content, for example, an advertisement to a higher degree, and to generate a higher revenue from the users without requiring the users to directly pay for the media content. Furthermore, there is a need for a computer implemented method and system that allows gating of static content and multimedia content hosted on a content delivery platform such as a website.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The computer implemented method and system disclosed herein addresses the above stated needs for controlling grant of access of media content to users based on multiple inputs such as decision criteria set by a media content owner, user characteristics, and other decision criteria. As used herein, the term “decision criteria” refers to parameters specified by the media content owner to influence lock decision behavior. Also, as used herein, the term “user” refers to a person or a group of persons or entities that accesses a content delivery platform, for example, a website, a web page, a web application, a software application on a mobile device, etc., that hosts and delivers media content on a content display interface, for example, a web page, for viewing, obtaining information, performing activities such as watching videos, listening to audio clips, playing games, social networking, etc., and utilizing the content delivery platform for any other purpose. Also, as used herein, the term “media content owner” refers to an entity that generates and delivers media content to a user. Media content owners comprise, for example, website publishers, newspapers, magazines, radio station operators, etc. Furthermore, the computer implemented method and system disclosed herein enables users to engage with media content, for example, an advertisement displayed on the content display interface to a higher degree and generate higher revenue from the users without requiring the users to directly pay for the media content. Furthermore, the computer implemented method and system disclosed herein allows gating of static content and multimedia content hosted on the content delivery platform. As used herein, the term “gating” refers to a locking mechanism, where first media content, for example, content of a web page is completely removed and replaced with one or more dynamic media content objects comprising, for example, sponsored content, until a user meets an access condition. Gating, in general, restricts access to the first media content. Also, as used herein, the term “static content” refers to content that can be presented to a user on the content display interface all at once. The static content comprises, for example, web pages, textual articles, photographs, etc. Also, as used herein, the term “multimedia content” refers to content, for example, video content or audio content that is presented to the user over a period of time determined by the length of a content segment. Also, as used herein, the term “first media content” refers to user selected content, for example, a video clip, an audio clip, an article, written text content, a television show, a collection of photographs, a game or an application, a voucher or an offer to obtain a special price on a purchase, a recipe, entry to a sweepstakes competition, etc., that is rendered by the content delivery platform for providing information and experiences to users of the content delivery platform. In an embodiment, the first media content comprises, for example, structured hypertext markup language content including static content and multimedia content.

The computer implemented method and system disclosed herein provides a content access management application executable by at least one processor configured to control grant of access to first media content hosted on a content delivery platform to a user. The content access management application detects a user attempt to access the first media content on a content display interface. The content display interface is a graphical user interface, for example, a web page of a website, an online web interface, a web based downloadable application interface, a mobile based downloadable application interface, etc.

The content access management application dynamically analyzes user characteristics on detection of the user attempt to access the first media content. The analyzed user characteristics comprise, for example, user information, device information, user activity, user history, user interests, user preferences, subscription status, user value scores, user profile information, audience profile information, etc. In an embodiment, the content access management application assigns user value scores to each of multiple users based on offer availability, that is, an availability of advertisers that want to sponsor each user and the premium that the advertisers are willing to pay to display second media content to each user based on demographic information obtained from prior usage of the content delivery platform. As used herein, the term “second media content” refers to interactive media content used to unlock the first media content. The second media content comprises, for example, one or more of advertisements such as a video advertisement, an audio advertisement, etc., games such as puzzles, videos, audio messages, surveys, online tasks, etc.

The content access management application receives decision criteria via a criteria reception interface provided by the content access management application. As used herein, the term “criteria reception interface” refers to a graphical user interface provided by the content access management application for receiving data from media content owners. The decision criteria comprise, for example, one or more of preset rules, preset user segments, preset content segments, preset segment optimization goals, etc., that are preset by a media content owner of the content delivery platform using the criteria reception interface.

The content access management application generates monetization strategies for each user that determines the type of first media content to be locked for each user, when the first media content is locked for each user, how frequently the first media content is locked for each user, a type of lock mechanism to be used during each attempt to lock the first media content for each user, etc., using the analyzed user characteristics and one or more of the received decision criteria. The content access management application processes various inputs comprising one or more of the decision criteria received via the criteria reception interface, the analyzed user characteristics, etc., to generate monetization strategies.

The content access management application dynamically creates one or more dynamic media content objects based on the analyzed user characteristics and one or more of the received decision criteria. As used herein, the term “dynamic media content object” refers to a dynamic placement comprising sponsored media content that is inserted into the content display interface for creating monetization opportunities. Each of the dynamically created dynamic media content objects comprises the second media content. In an embodiment, each of the dynamically created dynamic media content objects communicates with a content server via a network for loading and displaying the second media content. Each dynamic media content object is configured as a locking media content object with an access condition or a non-locking media content object for controlling grant of access of the first media content to a user. As used herein, the term “access condition” refers to a condition that a user must perform in order to unlock the first media content. The access condition defines one or more engagement tasks with the second media content to be completed. The engagement tasks comprise, for example, completing a challenge response for confirming full attention to the second media content, selecting and listening to audio content such as an audio clip, selecting and viewing multimedia content such as a media clip, answering survey questions, sharing information with social media contacts, answering a quiz correctly, completing a game, confirming attention paid to a media clip, downloading the second media content hosted on or outside a content application server, downloading an application hosted on or outside the content application server, creating a user profile on a content delivery platform, visiting another content display interface such as another web page, liking the advertiser on a social networking platform through a like option, filling in a form, joining an electronic mailing list, solving a mathematical equation, making a payment through a payment mode such as with a credit card, an online wallet, or another payment method, choosing to apply points or credits earned during prior interactions with the content delivery platform or through other reward programs or loyalty programs, etc., and any combination thereof.

In an embodiment, the content access management application continuously analyzes engagement data of the content delivery platform to determine monetization strategies for optimizing revenue generation and the dynamic creation of one or more dynamic media content objects, and promoting desired user behavior on the content delivery platform. The engagement data comprises, for example, user level metrics and site wide engagement metrics which are continuously calculated and analyzed by the content access management application to determine the monetization strategies.

The content access management application dynamically inserts the dynamically created dynamic media content objects into one or more sections of the content display interface based on the analyzed user characteristics and one or more of the received decision criteria. The content access management application dynamically inserts the dynamically created dynamic media content objects into one or more sections of the content display interface, for example, by replacing the first media content with the dynamically created dynamic media content objects, by gating the first media content with the dynamically created dynamic media content objects, or by obscuring the first media content with the dynamically created dynamic media content objects. Each of the dynamically inserted dynamic media content objects either restricts access of the first media content displayed on the content display interface to a user until the access condition is met or grants access to the first media content while displaying the second media content. The content access management application generates and renders notifications with instructions to be transmitted to the user during the dynamic insertion of the dynamically created dynamic media content objects into one or more sections of the content display interface.

The content access management application locks the first media content, renders or displays the second media content on the content display interface to the user, and unlocks the first media content when the access condition is met by the user. In an embodiment, the content access management application locks the first media content at a time instant when a user accesses the content display interface. In another embodiment, the content access management application locks the first media content after a user performs one or more of a predefined set of actions on the content display interface. In another embodiment, the content access management application grants time based access of the first media content to a user based on time spent by the user in engaging with the second media content. In another embodiment, the content access management application dynamically inserts another dynamically created dynamic media content object into one or more sections of the content display interface after the access condition contained in a previous dynamically created dynamic media content object is met. For example, the content access management application dynamically inserts a non-locking media content object into one or more sections of the content display interface after the user has met the access condition for a previously inserted locking media content object. In an embodiment, the locking media content object inserted by the content access management application provides a preview of the first media content based on a content type of the first media content. In an embodiment, the content access management application generates reports pertaining to, for example, one or more of revenue generated, targets achieved, frequency of locking of the first media content, and other information requested by the media content owner.

The content access management application can customize monetization strategies and website experiences for each user by choosing from a range of placement types and sponsored content material, for example, videos, surveys, display banners, interactive advertisement units, etc. The content access management application provides media content owners access to new and growing revenue. The content access management application provides a scalable cross-platform solution and greater audience insight to media content owners. The content access management application also provides advertisers with access to premium inventory at scale, premium content adjacency, high transparency, and industry leading click through rate (CTR)/view-through rate (VTR) performance. Click through rate (CTR) measures the success of an advertisement for a particular website as well as the effectiveness of an electronic mail (email) campaign by the number of users that clicked a specific link. View through rate (VTR) measures the number of post impression response or view-through from display media impressions viewed during and following an advertisement. The content access management application provides a click to play user-initiated advertising environment. The content access management application also allows advertising brands to pay on a cost per view (CPV) basis and have complete visibility over who watches their advertisements. The content access management application allows media content owners to gate any type of first media content comprising, for example, articles, photo galleries, recipes, sweepstakes, etc., on the content delivery platform. The content access management application allows media content owners to monetize international traffic. The content access management application also allows media content owners to use their own advertisements in the dynamic media content objects inserted on the content display interface of the content delivery platform.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein. The description of a structure or a method step referenced by a numeral in a drawing carries over to the description of that structure or method step shown by that same numeral in any subsequent drawing herein.

FIG. 1A illustrates a computer implemented method for controlling grant of access to first media content hosted on a content delivery platform.

FIG. 1B illustrates an embodiment of the computer implemented method for controlling grant of access to first media content hosted on the content delivery platform.

FIGS. 2A-2B exemplarily illustrate a flowchart comprising the steps performed by a content access management application for controlling grant of access to first media content hosted on the content delivery platform.

FIG. 3 exemplarily illustrates a block diagram showing user data collection and storage, real time user valuation, media content owner controls, and reporting and optimization functions performed by the content access management application for controlling grant of access to first media content.

FIG. 4 exemplarily illustrates a process flow diagram showing components of the content access management application involved in determining an optimal monetization strategy for a user based on decision criteria.

FIG. 5 exemplarily illustrates a block diagram showing a value assessment and value exchange process implemented by the content access management application for controlling grant of access to first media content hosted on the content delivery platform.

FIG. 6 exemplarily illustrates a process flow diagram comprising the steps performed by the content access management application for granting access to first media content based on a lock decision.

FIGS. 7A-7B exemplarily illustrate screenshots of a content display interface of the content delivery platform, showing a dynamic media content object dynamically inserted into a section of the content display interface.

FIG. 8 exemplarily illustrates a graphical representation showing a relationship between user attention and engagement with second media content and access to first media content determined by the content access management application for a particular user.

FIG. 9 exemplarily illustrates a computer implemented system for controlling grant of access to first media content hosted on the content delivery platform.

FIG. 10 exemplarily illustrates the architecture of a computer system employed by the content delivery platform for controlling grant of access to first media content hosted on the content delivery platform.

FIGS. 11A-11D exemplarily illustrate screenshots of the content display interface of the content delivery platform, showing different locking mechanisms and a non-locking media content object employed by the content access management application.

FIGS. 12A-12E exemplarily illustrate screenshots of the content display interface of the content delivery platform with controlled grant of access to the first media content on the content display interface.

### DETAILED DESCRIPTION OF THE INVENTION

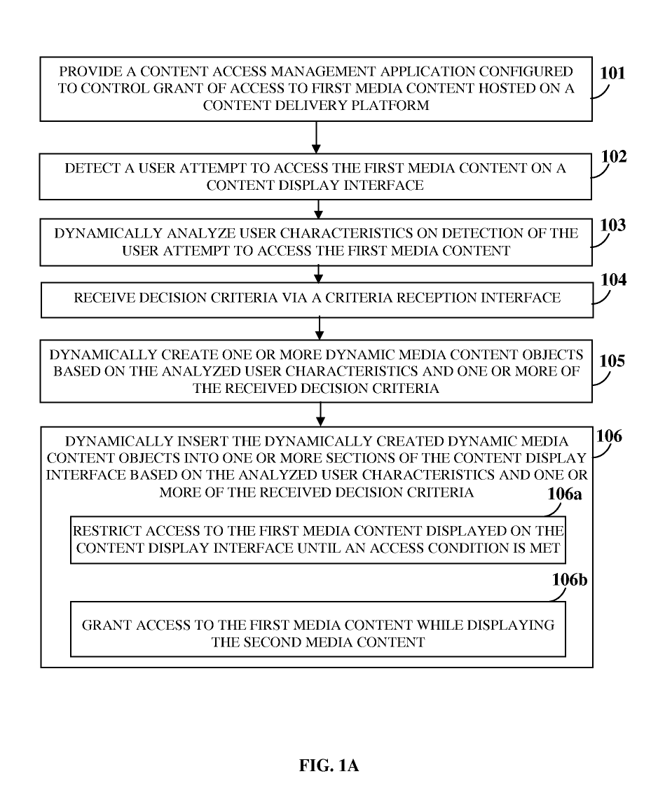

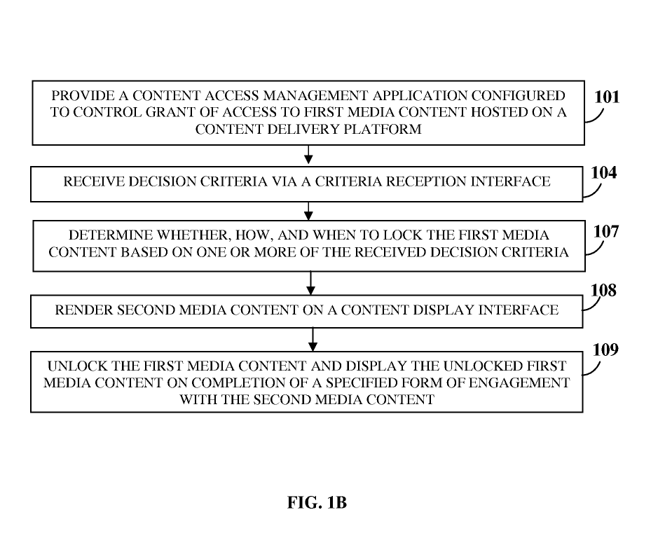

FIG. 1A illustrates a computer implemented method for controlling grant of access to first media content hosted on a content delivery platform, for example, a website, a web page, a web application, a software application on a mobile device, etc., to a user. As used herein, the term “first media content” refers to user selected content, for example, a video clip, an audio clip, an article, written text content, a television show, a collection of photographs, a game or an application, a voucher or an offer to obtain a special price on a purchase, a recipe, entry to a sweepstakes competition, etc., that is rendered by the content delivery platform for providing information and experiences to users of the content delivery platform. In an embodiment, the first media content comprises, for example, structured hypertext markup language (HTML) content including static content and multimedia content. As used herein, the term “static content” refers to content that can be presented to a user on a content display interface, for example, a web page all at once. The static content comprises, for example, web pages, textual articles, photographs, etc. Also, as used herein, the term “multimedia content” refers to content, for example, video content or audio content that is presented to the user over a period of time determined by the length of a content segment. Also, as used herein, the term “user” refers to a person or a group of persons or entities that accesses the content delivery platform that hosts and delivers the first media content on the content display interface, for example, for viewing, obtaining information, performing activities such as watching videos, listening to audio clips, playing games, social networking, etc., and utilizing the content delivery platform for any other purpose.

The computer implemented method disclosed herein provides 101 a content access management application executable by at least one processor configured to control grant of access to the first media content hosted on the content delivery platform. The content access management application allows adaptive media content monetization that is tailored to the characteristics of each user. The content access management application assesses the value of each audience member or user and allows the user to pay for access to the first media content by consuming second media content comprising, for example, video advertisements, audio advertisements, etc. The content access management application therefore provides a payment model for the content delivery platform and other connected devices worldwide via exchange of metered attention to the first media content. In an embodiment, the content access management application is deployed on the content delivery platform. Once the content access management application is deployed on the content delivery platform, the content access management application can modify content display interfaces, for example, web pages hosted on the content delivery platform, before the content display interfaces are displayed to users. The content access management application creates monetization opportunities on the content delivery platform by inserting dynamic placements containing sponsored media content into web pages requested by the users.

The content delivery platform and the content access management application is accessible to media content owners and the users, for example, through a broad spectrum of technologies and devices such as personal computers with access to the internet, internet enabled cellular phones, tablet computing devices, etc., via a network. As used herein, the term “media content owner” refers to an entity that generates and delivers media content to a user. Media content owners comprise, for example, website publishers, newspapers, magazines, radio station operators, etc. The network is, for example, the internet, an intranet, a wireless network, a network that implements WiFi® of the Wireless Ethernet Compatibility Alliance, Inc., an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a long-term evolution (LTE) mobile communication network, a public telephone network, etc., a local area network, a wide area network, an internet connection network, an infrared communication network, etc., or a network formed from any combination of these networks.

The content access management application detects 102 a user attempt to access the first media content on the content display interface. The content display interface is a graphical user interface, for example, a web page of a website, an online web interface, a web based downloadable application interface, a mobile based downloadable application interface, etc. The content access management application is accessible to users via multiple user devices via the network. As used herein, the term “user device” refers to an electronic device utilized by a user to access the first media content via the network. The user device is, for example, a personal computer, a tablet computing device, a mobile computer, a mobile phone, a smart phone, a portable computing device, a laptop, a personal digital assistant, a touch centric device, a workstation, a client device, a portable electronic device, a network enabled computing device, an interactive network enabled communication device, a gaming device, a set top box, a television, a web browser, any other suitable computing equipment, and combinations of multiple pieces of computing equipment, etc. The user device may also be a hybrid device that combines the functionality of multiple devices. Examples of a hybrid device comprise a cellular telephone that includes a media player functionality, a gaming device that includes a wireless communications capability, a cellular telephone that includes game and electronic mail (email) functions, and a portable device that receives email, supports mobile telephone calls, has music player functionality, and supports web browsing.

The content access management application dynamically analyzes 103 user characteristics on detection of the user attempt to access the first media content. The analyzed user characteristics comprise, for example, user information, device information, user activity, user history, user interests, user preferences, subscription status, user value scores, user profile information, audience profile information, etc. In an embodiment, the content access management application assigns a user value score to each of multiple users based on offer availability, that is, an availability of advertisers that want to sponsor each user and the premium that the advertisers are willing to pay to display the second media content to each user based on demographic information obtained from prior usage of the content delivery platform. The demographic information comprises, for example, gender, age, ethnicity, knowledge of languages, disabilities, mobility, home ownership, employment status, location, etc., of the user. The demographic information can also be obtained, for example, by presenting a survey question to the user or from a third party by reference to a third party tracking cookie on a browser of the user device. In an embodiment, the content access management application creates a user profile for each user of the content delivery platform to store and analyze user behavior and determine an optimal or ideal monetization strategy for the user in real time and for future sessions.

The content access management application receives 104 decision criteria via a criteria reception interface provided by the content access management application. As used herein, the term “criteria reception interface” refers to a graphical user interface provided by the content access management application for receiving data from media content owners. Also, as used herein, the term “decision criteria” refers to parameters specified by the media content owner to influence lock decision behavior. The decision criteria comprise, for example, one or more of preset rules, preset user segments, preset content segments, preset segment optimization goals, etc., that are preset by a media content owner of the content delivery platform using the criteria reception interface.

In an embodiment, the content access management application generates monetization strategies that determine type of the first media content to be locked for each user, when the first media content is locked for each user, how frequently the first media content is locked for each user, a type of lock mechanism to be used during each attempt to lock the first media content for each user, etc., using the analyzed user characteristics and one or more of the received decision criteria. The content access management application processes various inputs comprising the decision criteria received via the criteria reception interface, the user characteristics, etc., to generate the monetization strategies. In an embodiment, the content access management application adjusts monetization strategies based on the assigned user value scores. In an embodiment, if no offer is available to a particular user, the user value score of the user is lowered such that first media content is never locked. In another embodiment, if one or more offers are available to a user and the premium offered by advertisers to display second media content to the user is very low, the user value score is adjusted such that content is locked more frequently than for those users for whom advertisers are willing to pay a higher premium.

The content access management application dynamically creates 105 one or more dynamic media content objects based on the analyzed user characteristics and one or more of the received decision criteria. As used herein, the term “dynamic media content object” refers to a dynamic placement comprising sponsored media content that is inserted into the content display interface for creating monetization opportunities. In an embodiment, the content access management application continuously analyzes engagement data of the content delivery platform to determine monetization strategies for optimizing revenue generation and the dynamic creation of one or more dynamic media content objects, and promoting desired user behavior on the content delivery platform. The engagement data comprise, for example, user level metrics and site wide engagement metrics which are continuously calculated and analyzed by the content access management application to determine monetization strategies. Each of the dynamically created dynamic media content objects comprises second media content. As used herein, the term “second media content” refers to interactive media content used to unlock the first media content. The second media content comprises, for example, one or more of advertisements such as a video advertisement, an audio advertisement, etc., games such as puzzles, videos, audio messages, surveys, online tasks, etc. In an embodiment, each of the dynamically created dynamic media content objects communicates with a content server via the network for loading and displaying the second media content.

Each dynamic media content object is configured as a locking media content object with an access condition, or a non-locking media content object for controlling grant of access to the first media content. As used herein, the term “access condition” refers to a condition that a user must perform, for example, watch a video, answer a survey, etc., in order to unlock the first media content. The locking media content objects restrict access to the first media content that the user wants to consume on the content display interface in such a way that the user must engage with the second media content or the sponsored media content and satisfy an unlock condition in order to gain access to the first media content. In an embodiment, the content access management application recognizes only one class of locking media content objects. However, the visual layout and functionality of the locking media content objects may vary based on the type of locking mechanism used. One locking mechanism may be preferred over another for displaying a particular type of sponsored content. The non-locking media content objects can be inserted into the content display interface in such a way that the user is able to access the first media content at the same time as the second media content. The non-locking media content objects do not restrict user access to the first media content on the content display interface. In an embodiment, the non-locking media content objects can be injected at any time. The content access management application recognizes many classes of non-locking media content objects including, for example, banner placements of different sizes, pop up placements, leave-behind placements, etc.

The content access management application dynamically inserts 106 the dynamically created dynamic media content objects into one or more sections of the content display interface based on the analyzed user characteristics and one or more of the received decision criteria. In an embodiment, the content access management application dynamically injects the dynamic media content objects on any web page after the user's browser has requested the web page. The content access management application dynamically inserts the dynamically created dynamic media content objects into one or more sections of the content display interface, for example, by replacing the first media content with the dynamically created dynamic media content objects, gating the first media content with the dynamically created dynamic media content objects, or obscuring the first media content with the dynamically created dynamic media content objects. As used herein, the term “gating” refers to a locking mechanism employed by the content access management application, where the first media content of a web page is completely removed and replaced with one or more dynamic media content objects comprising, for example, sponsored content, until a user meets an access condition. Gating, in general, restricts access to the first media content. In an embodiment, the content access management application generates and renders notifications with instructions to be transmitted to the user during the dynamic insertion of the dynamically created dynamic media content objects into one or more sections of the content display interface.

Each of the dynamically inserted dynamic media content objects either restricts access 106a to the first media content displayed on the content display interface until the access condition is met or grants access 106b to the first media content while displaying the second media content. For example, the locking media content object comprising the second media content and the access condition restricts access to the first media content displayed on the content display interface until the access condition is met, while the non-locking media content object grants access to the first media content while displaying the second media content. The content access management application locks the first media content, renders the second media content on the content display interface, and unlocks the first media content when the access condition is met. The access condition defines one or more of multiple engagement tasks with the second media content to be completed. The engagement tasks comprise, for example, completing a challenge response for confirming full attention to the second media content, selecting and listening to audio content such as an audio clip, selecting and viewing multimedia content such as a multimedia clip, answering survey questions, sharing information with social media contacts, answering a quiz correctly, completing a game, confirming attention paid to a media clip, downloading the second media content hosted on or outside a content application server, downloading an application hosted either on or outside the content application server, creating a user profile on the content delivery platform, visiting another content display interface such as another web page, liking an advertiser on a social networking platform through a like option, filling in a form, joining an electronic mailing list, solving a mathematical equation, making a payment through a payment mode such as with a credit card, an online wallet, or another payment method, choosing to apply points or credits earned during prior interactions with the content delivery platform or through other reward programs or loyalty programs, etc., and any combination thereof.

In an embodiment, the content access management application allows media content owners to apply different lock settings to different sections of the content display interface. For example, the media content owners can set photo gallery content to be locked more frequently than other editorial content. The content access management application further provides an asynchronous mode setting that can be used to lock photo gallery pages after the user has viewed a certain number of photographs. In an embodiment, the locking media content object provides a preview of the first media content based on a content type of the first media content. For example, the content access management application provides users with a short preview of a text article by retaining the first paragraph of the text article while locking the remaining part of the text article. The preview is visible during a web page lock. This results in increased engagement of the users with the dynamic media content object or the second media content.

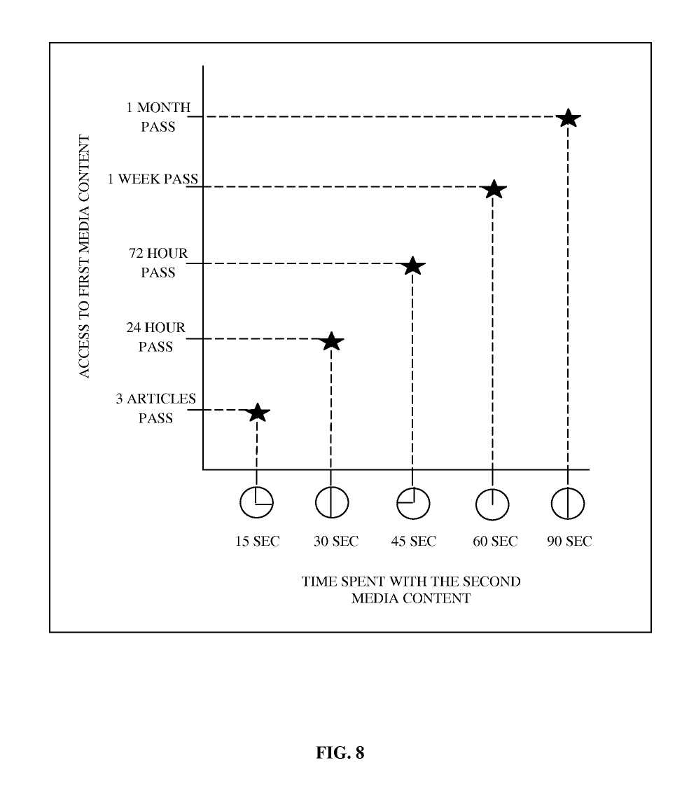

In an embodiment, the content access management application locks the first media content at a time instant when a user accesses the content display interface. For example, the content access management application locks the first media content as soon as the user lands on a web page. In another embodiment, the content access management application locks the first media content after a user performs one or more of a predefined set of actions on the content display interface. For example, if a web page displays a photo gallery, the content access management application locks the first media content only once the user has browsed through a certain number of images in the photo gallery. In another example, the content access management application locks the first media content only once the user has scrolled past a certain point on the content display interface or the web page. In another embodiment, the content access management application grants time based access to the first media content to the user based on time spent by the user in engaging with the second media content as disclosed in the detailed description of FIG. 8. In another embodiment, the content access management application dynamically inserts another dynamically created dynamic media content object into one or more sections of the content display interface after the access condition contained in a previous dynamically created dynamic media content object is met. For example, the content access management application inserts a non-locking media content object after an access condition or an unlock condition of a previously inserted locking media content object has been met. Each locking media content object displayed to the user will set an access condition that the user must meet in order to access the first media content. The access condition varies depending on the type of the second media content loaded into the locking media content object. In another example, the content access management application inserts multiple locking media content objects as soon as the content display interface or the web page loads. In an embodiment, the content access management application generates reports pertaining to, for example, one or more of revenue generated, targets achieved, frequency of locking of the first media content, and other information requested by the media content owner. The generated reports are accessible by a media content owner via the content display interface.

In another embodiment, the content access management application generates a user interface to allow a user to perform one or more of the following: register with the content access management application or the content delivery platform and create a user account or a user profile, log in and access the user account, set preferences for the user interface, provide information about interests and characteristics of the user for targeting advertisements to the user, revisit previously viewed media content, earn credits by interacting with the second media content, etc. The user interface enables the user to earn and store credits in the user account for future use, and to redeem credits to unlock the first media content. If the user registers with the content access management application or the content delivery platform or is tagged as a user of the content access management application, for example, by use of a browser cookie, the user can interact with the user interface at other media sources that implement the content access management application and have access to the same user-specific profile information, settings, credit balances, etc. In another embodiment, the content access management application creates a user profile for each user for storing the analyzed user characteristics to determine a monetization strategy for the dynamic creation of one or more dynamic media content objects for each users in real time and for future sessions.

FIG. 1B illustrates an embodiment of the computer implemented method for controlling grant of access to the first media content hosted on the content delivery platform. The computer implemented method disclosed herein provides 101 the content access management application as disclosed in the detailed description of FIG. 1A. The content access management application receives 104 the decision criteria via the criteria reception interface provided by the content access management application. The content access management application determines 107 whether, how, and when to lock the first media content based on one or more of the received decision criteria. The content access management application renders 108 second media content on the content display interface. The content access management application unlocks 109 the first media content and displays the unlocked first media content on the content display interface to the user on completion of a specified form of engagement with the second media content.

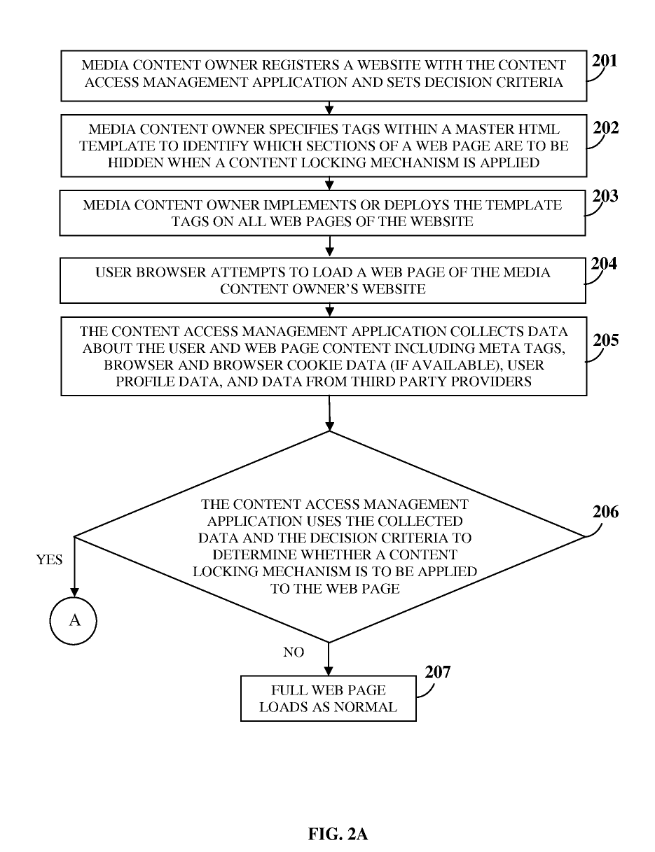

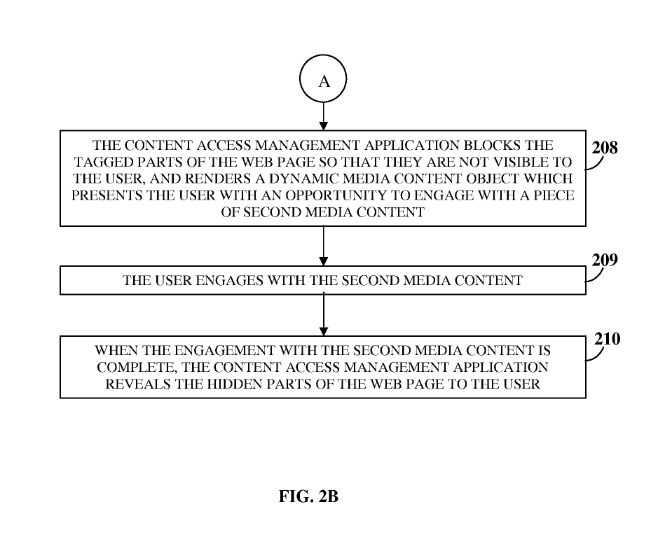

FIGS. 2A-2B exemplarily illustrate a flowchart comprising the steps performed by the content access management application for controlling grant of access to first media content hosted on the content delivery platform. The content access management application that controls grant of access to the first media content is accessible by media content owners via media content owner devices, for example, personal computers, laptops, smart phones, tablet computing devices, etc. The content access management application is executed when a user attempts to access media content on a particular content display interface, also referred to herein as a “web page”, hosted by the content delivery platform, also referred to herein as a “website”. The media content owner registers 201 the website hosting the first media content with the content access management application and sets the decision criteria for granting access to the first media content on the content delivery platform. The media content owner specifies 202 template tags, for example, labels such as division tags or “div” tags on the web page, a list of cascading style sheet (CSS) classes, etc., within a master hyper text markup language (HTML) template of the website to identify which sections of the web page are to be hidden when the content access management application applies a content locking mechanism. The content access management application applies multiple locking mechanisms, for example, in-page locking for premium first media content, asynchronous locking for photo galleries, interstitial locking, etc. The media content implements or deploys 203 the template tags on all web pages of the website that hosts the first media content. When a user's browser attempts 204 to load a web page of the media content owner's website, the content access management application collects 205 user data and web page content, for example, meta tags, browser information, browser cookie data, user profile information, and data from third party providers.

The content access management application determines 206 whether a content locking mechanism is to be applied to the web page using the collected data and the decision criteria. The decision criteria comprise decision rules or the preset decision rules obtained from a decisioning module of the content access management application. The decision rules comprise information and preferences obtained from the media content owner via the criteria reception interface provided by the content access management application. If the content access management application determines not to apply the content locking mechanism, then the first media content is not locked and the web page loads 207 as normal. If the content access management application decides to apply the content locking mechanism to the web page, then the content access management application blocks 208 the tagged parts of the web page identified by the media content owner, so that they are hidden from and are not visible to the user, and renders a dynamic media content object which presents the user with an opportunity to engage with a piece of second media content. For example, the dynamic media content object presents the user with an opportunity to select a video to watch. In an embodiment, the content access management application also generates a notification to be presented to the user with instructions for the user to follow in order to access the first media content, that is, the hidden parts of the web page. The user engages 209 with the second media content, for example, by clicking a play button on the video and watching the video. When the engagement of the user with the second media content is complete, that is, when the video finishes playing and the user interacts correctly with the second media content as defined by the access condition, the content access management application unlocks the first media content and reveals 210 the hidden parts of the web page to the user.

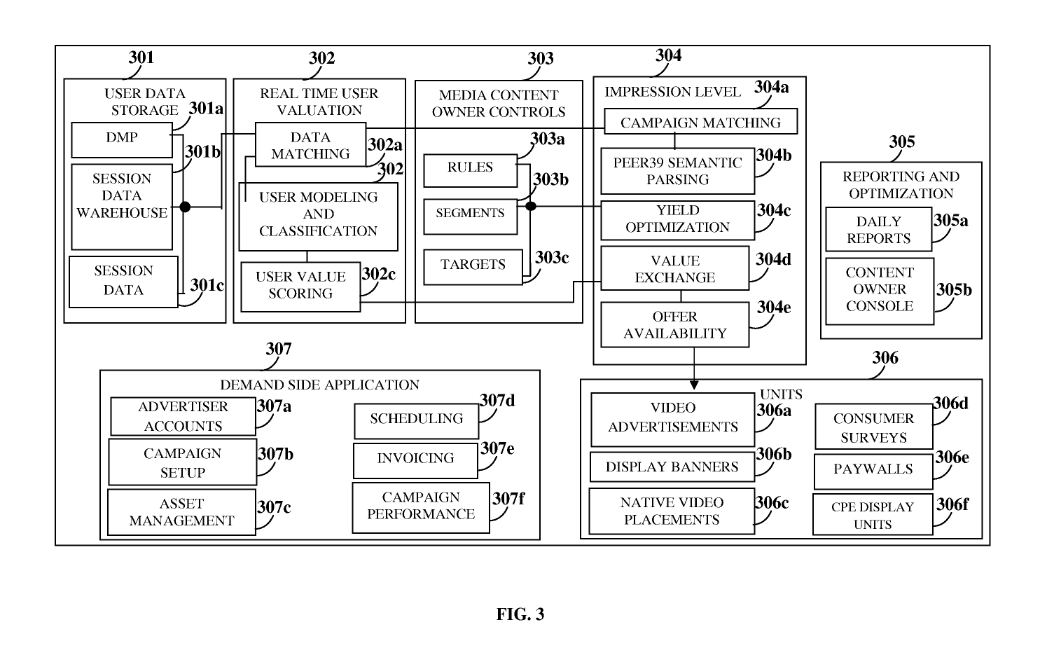

FIG. 3 exemplarily illustrates a block diagram showing user data collection and storage, real time user valuation, media content owner controls, and reporting and optimization functions performed by the content access management application for controlling grant of access to first media content. The content access management application collects user data via multiple sources, for example, data management platforms (DMPs) 301a such as Lotame® of Lotame Solutions, Inc., session data 301c, etc., and stores 301 the collected user data in a session data warehouse 301b. The content access management application evaluates 302 the user data in the session data warehouse 301b for data matching 302a, user modeling and classification 302b, and user value scoring 302c. The content access management application also receives media content owner control information 303 comprising rules 303a, custom segments 303b, targets 303c, etc., from the media content owners for setting the decision criteria.

The content access management application creates 304 impression level decisions such as decisions about whether to deliver an impression of the second media content using the real time user valuation information obtained via data matching 302a and user value scoring 302c. Information obtained by data matching 302a is used for campaign matching 304a, for example, via Peer39® semantic parsing 304b. Information obtained by user value scoring 302c is used for calculating a value exchange 304d based on offer availability 304e of advertisement units 306 such as video advertisements 306a, display banners 306b, native video placements 306c, consumer surveys 306d, paywalls 306e, and cost per engagement (CPE) display units 306f. As used herein, the term “paywall” is a system that prevents users from accessing the first media content without a paid subscription. The content access management application performs yield optimization 304c using the media content owner control information 303. The content access management application performs 305 reporting and optimization by providing daily reports 305a to the media content owners which can be accessed via a content owner console 305b. Furthermore, the content access management application connects to an advertiser demand side application 307 that manages advertiser accounts 307a, a campaign setup 307b, asset management 307c, scheduling 307d, invoicing 307e, etc., and generates analytics on campaign performance 307f.

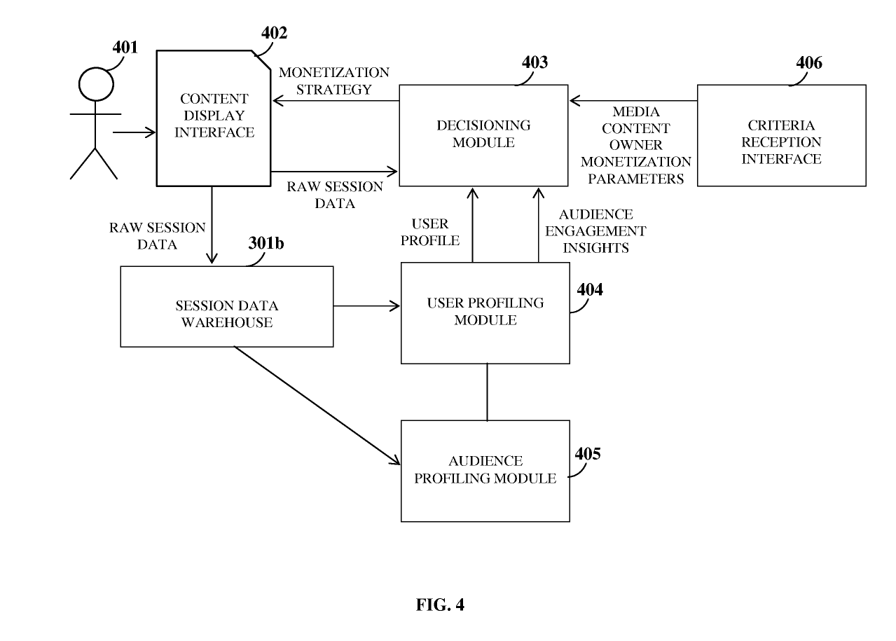

FIG. 4 exemplarily illustrates a process flow diagram showing components of the content access management application involved in determining an optimal monetization strategy for a user 401 based on decision criteria. The components of the content access management application comprise a criteria reception interface 406, a decisioning module 403, a user profiling module 404, and an audience profiling module 405. When the user 401 accesses the content display interface 402, also referred to as a “web page”, of the content delivery platform, also referred to as a “website”, the content access management application collects raw session data and stores the collected raw session data in the session data warehouse 301b. The user profiling module 404 and the audience profiling module 405 access the data stored in the session data warehouse 301b for analyzing user characteristics and engagement data. The user profiling module 404 generates a user profile based on the analysis and provides audience engagement insights to the decisioning module 403. The raw session data and media content lock parameters or the decision criteria set by media content owners via the criteria reception interface 406 are also input to the decisioning module 403.

The decisioning module 403 determines access conditions of the dynamic media content objects based on the decision criteria. The decisioning module 403 computes a monetization strategy for each user 401 or visitor to the website. The monetization strategy comprises a set of rules for the locking media content objects and another set of rules for the non-locking media content objects to be rendered on the content display interface 402 in a session. These rules, also referred to herein as “monetization strategy rules”, determine when, where, and how frequently the dynamic media content objects will be displayed on the content display interface 402. The monetization strategy rules comprise, for example, frequency capping rules, session depth rules, content based rules, and lock mechanism rules. The frequency capping rules place an upper limit on the number of times the locking media content objects can be displayed to the user 401 in a particular time period. The frequency capping rules limit the number of times the first media content can be locked for the user 401 during that time period. For example, the first media content can be locked a maximum of 3 times in 48 hours. In this example, the frequency cap is set as 3/48. In another example, the first media content can be locked as many times a required, that is, the frequency cap is set to none. In another example, the first media content cannot be locked for the user 401 for a 24 hour time period. The frequency cap in this example is 0/24. If the user 401 does not complete an engagement task on the second media content before navigating to another content display interface 402 or web page on the website, the content access management application does not count the dynamic media content object towards the frequency cap.

The session depth rules determine when a certain dynamic media content object is displayed during a session. As used herein, the term “session depth” refers to the number of web pages viewed by a user 401 during a particular session or during a specified amount of time. That is, the session depth of a user 401 in a particular session is the number of page views the user 401 has accessed in the session including the current page view. For example, on the user's 401 fourth page view in a session, the session depth is 4. A session comprises a sequence of web page views consumed by the user 401 before the user 401 leaves the website, or before a set period of browser inactivity. The session depth rules for the locking media content objects can be used in conjunction with frequency capping rules. For example, the content access management application inserts a locking media content object on a user's 401 first web page view followed by uninterrupted access to 3 articles before the user 401 encounters another locking media content object on the fifth web page view. The session depth in this example, is set as 1, 5. In another example, the user 401 encounters a locking media content object on the second web page view and the fourth web page view, followed by uninterrupted access to the first media content for 24 hours. The session depth in this example, is 2, 4, etc., and frequency cap is 2/24, that is two times in 24 hours. In this example, the frequency capping rules take precedence over the session depth rules in such a way that once the frequency cap is reached, the session depth rules cannot be applied. In another example, the user 401 may view a particular class of non-locking media content objects on the first, third, and fifth web page views only when the session depth is set as 1, 3, and 5.

The content based rules consider the content type of the first media content encountered by the user 401 on each web page view. For example, the content access management application creates and displays a locking media content object on the content display interface 402 when the first media content such as an article comprises a certain keyword. In another example, the content access management application creates and displays a non-locking media content object for all articles labeled as “breaking news”. When the content based rules and the frequency capping rules are used together, the content access management application determines which of the two takes precedence. The lock mechanism rules determine which lock mechanism will be utilized each time a locking media content object is displayed on the content display interface 402. For example, the content access management application utilizes a content gating lock mechanism on a first web page view followed by a content replacement on every other web page view. In this example, the content access management application sets the session depth as 1 and the placement type as a locking media content object for inserting the locking media content object in the first web page view, and the session depth as 2, 4, 6, etc., and the placement type is a locking media content object for replacing the locking media content object on every other web page view. The content gating lock mechanism completely removes content of a web page and replaces the content with sponsored content until the user 401 meets an access condition.

The decisioning module 403 of the content access management application determines an optimal monetization strategy for a user 401 by utilizing decisioning inputs. The decisioning inputs comprise, for example, raw session data, user profile information, and audience profile information. The raw session data comprises, for example, data points such as referral source information, geographic location, device information, browser information, and other web page level data that is accessible by the content access management application, number of previous web page views, etc. The raw session data is stored in the data warehouse 301b.

The user profiling module 404 provides the user profile information for determining the optimal monetization strategy for a user 401. The user profile information comprises, for example, aggregated session data, engagement history, subscription status of the user 401, and information about affinity groups of the user 401. The aggregated session data comprises, for example, the user's 401 frequency of visits to the website over a time period, average time spent on the website per visit by the user 401, top referral sources for the user 401, etc. The engagement history comprises, for example, details about sponsored content displayed to the user 401 by the content access management application. For example, the user profiling module 404 determines that the user 401 leaves the website 13% of the time when a locking media content object is displayed, the user 401 interacts with 3% of banner advertisements shown, the user 401 completes watching 20% of video advertisements shown, etc. The subscription status indicates, for example, whether the user 401 is a paid subscriber, whether the user 401 has been a paid subscriber in the past, etc. The information about the user's 401 affinity groups indicates, for example, whether the user 401 is an auto-enthusiast, the user 401 is aged between 18 years to 25 years, etc.

The audience profiling module 405 analyzes collective website usage for all users 401 of the website to compute aggregated usage and engagement metrics, and to determine how the engagement metrics correlate to user data and monetization strategies. The audience profiling module 405 provides the decisioning module 403 with the ability to draw insights comprising, for example, site wide engagement metrics, site wise usage metrics, correlations between data inputs and usage/engagement metrics, and correlations between monetization strategies and usage/engagement metrics. The site wide engagement metrics comprise, for example, abandon rate, view through rate, click through rate, etc. The abandon rate indicates the percentage of users 401 who leave the website when a locking media content object is displayed on the content display interface 402. The view through rate indicates the percentage of users 401 who complete an engagement task associated with the second media content, for example, watching a video advertisement shown to them. The click through rate indicates the percentage of users 401 who complete an interaction with a display/banner advertisement on the website. The site wide usage comprises, for example, average web page views per user 401, a bounce rate, top referral sources, average time on the website, etc. For correlations between data inputs and usage/engagement metrics, the audience profile generated by the audience profiling module 405 can be used, for example, to look up an abandon rate for search traffic, a completion rate for users 401 on mobile devices, average time spent on the website by users 401 based in the United States using mobile devices, etc. For correlations between monetization strategies and usage/engagement metrics, the audience profile generated by the audience profiling module 405 can be used, for example, to look up the abandon rate when a locking media content object is displayed on the second web page view. In another example, the audience profile generated by the audience profiling module 405 can be used to determine average time on the website when a locking media content object is shown on the first web page view.

The content access management application allows the media content owner, for example, a publisher to set decision criteria or monetization parameters via the criteria reception interface 406 to influence or control monetization strategies generated by the decisioning module 403 of the content access management application. The content access management application allows a media content owner to specify one set of parameters for the entire website or create different sets of parameters for predefined user segments and/or content segments via the criteria reception interface 406. The monetization parameters comprise, for example, user segments, content segments, explicit monetization strategies, parameters for segment optimization, and parameters for automatic segmentation. The media content owner can set different sets of parameters for different user segments via the criteria reception interface 406. The media content owner can create new user segments from any combination of raw session data inputs such as referral sources, device information, geographic location, etc., via the criteria reception interface 406. For example, the media content owner can create a user segment for mobile users 401 who arrive at the website from any social networking platform. In another example, the media content owner can create a user segment for users 401 located in the United States or for users 401 located in the United Kingdom. The media content owners can also create user segments based on data contained in the user profiles via the criteria reception interface 406. For example, the media content owner can a create a user segment for users 401 who visit the website more than 10 times in a month or for users 401 who spend more than 20 minutes on the website per visit. In another example, the media content owner can create a user segment for users 401 who were paid subscribers in the past.

The media content owner can set different sets of parameters for different types of content and/or pages on their websites or the content delivery platform via the criteria reception interface 406. For example, the media content owner can create a content segment for web pages that contain the keyword “weather”. In another example, the media content owner can create a content segment for web pages that include photo galleries. The content access management application allows media content owners to set explicit monetization strategies, for example, frequency capping rules, session depth rules, lock mechanism rules, content segment rules for any user segment or content segment via the criteria reception interface 406. In an embodiment, instead of specifying explicit monetization strategies, the media content owners can set success goals, for example, “maximize revenue”, “maximize time on site”, “maximize web page views”, etc., for any user 401 or content segment via the criteria reception interface 406. The media content owner can also set numeric revenue targets for the content access management application via the criteria reception interface 406. The decisioning module 403 utilizes the user profile information and the audience profile information to compute optimal strategies for each user segment based on the goals or targets set by the media content owner. The media content owners can also instruct the content access management application via the criteria reception interface 406 to automatically segment the audience to meet combination goals or targets. The decisioning module 403 automatically segments the audience based on insights derived from various data inputs.

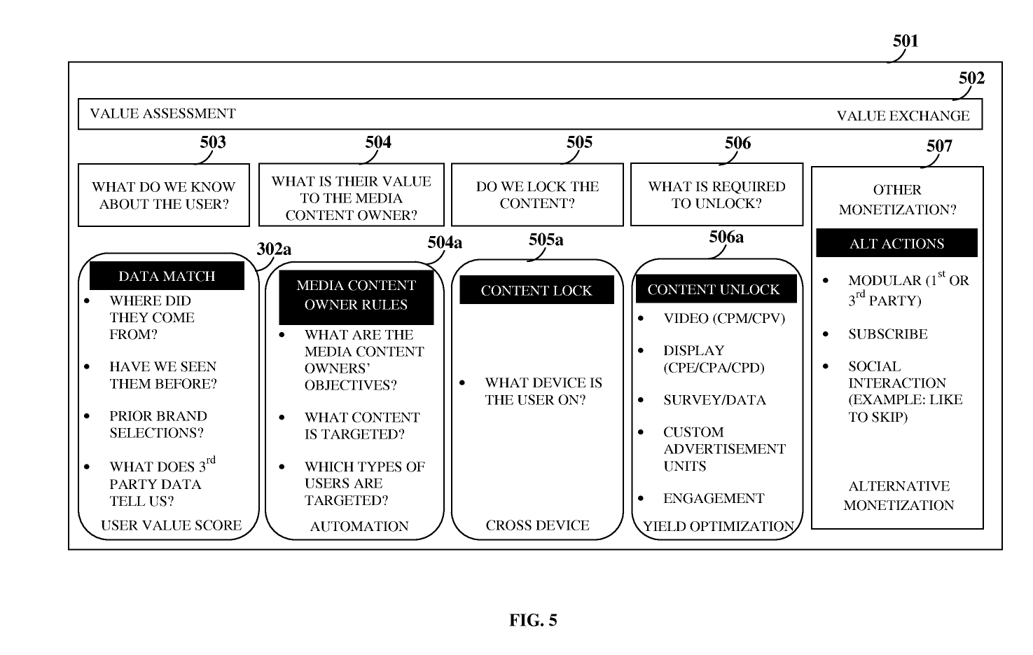

FIG. 5 exemplarily illustrates a block diagram showing a user value assessment and value exchange process implemented by the content access management application for controlling grant of access to first media content hosted on the content delivery platform. The content access management application performs user value assessments and value exchange operations 502 in a business intelligence layer 501. The content access management application performs user value assessments by first assessing 503 information about the user and determining a user value score via data matching 302a. The data matching operation 302a is performed by collecting information about the user, for example, where the user comes from, whether the user was known before, prior brand selections of the user, data provided by the third party applications, etc. The value assessment operation also comprises determining 504 the value of the user to the media content owner using automation rules 504a set by the media content owner. The automation rules comprise, for example, the objectives of the media content owner, information about what content is targeted, which type of users are targeted, etc. The content access management application also decides whether to lock 505 the first media content. One of the parameters used in the content lock decision is the device information 505a, for example, the device the user is utilizing to access the first media content. The content access management application further determines the type of second media content and what type of engagement with the second media content is required to unlock 506 the first media content. The decision as to which type of second media engagement to use involves yield optimization 506a among videos based on cost per impression (CPM) or cost per view (CPV), display advertisements based on cost per impression (CPM) or cost per engagement (CPE), or cost per action (CPA) or cost per click (CPC), survey data, custom advertisement units, etc,. The content access management application also performs value exchange operations via alternative monetization strategies 507 by using alternative actions, for example, social interactions, subscriptions, modular interactions such as first party or third party interactions, etc.

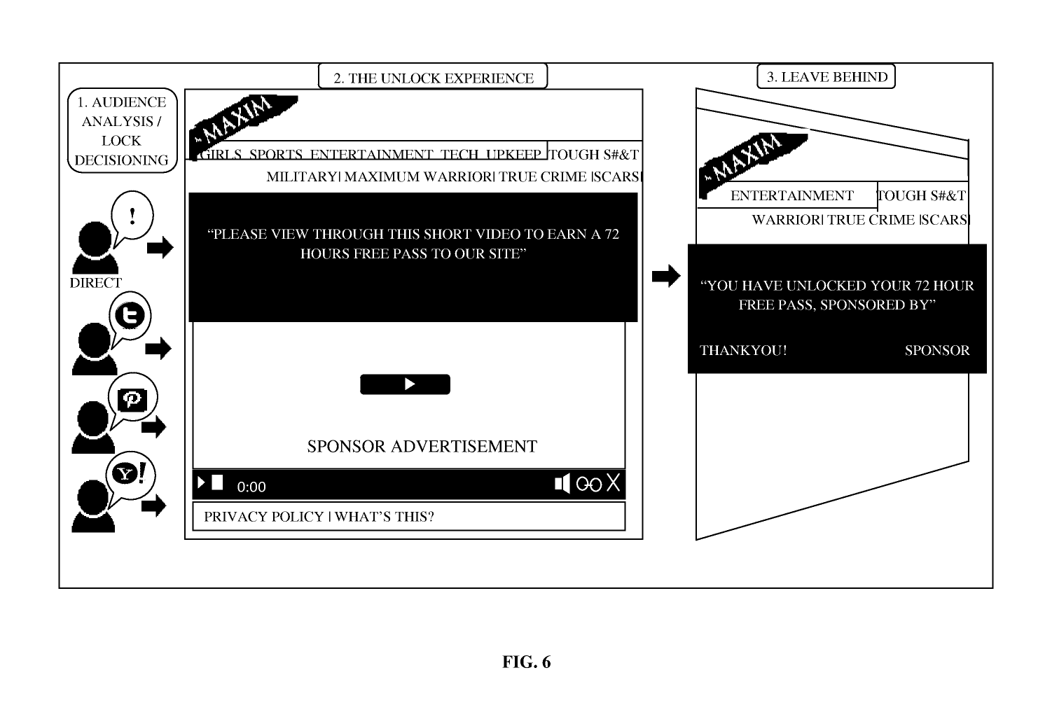

FIG. 6 exemplarily illustrates a process flow diagram comprising the steps performed by the content access management application for granting access to first media content based on a lock decision. When a user attempts to open a particular article from a collection of articles hosted by the media content owner on a content delivery platform, for example, a website, the content access management application performs audience analysis and lock decisioning, for example, based on the user information, the browser being used by the user, the content of the article, the referring website of the user such as Twitter of Twitter, Inc., Pinterest® of Pinterest, Inc., etc., demographic information acquired from the user, for example, by presenting a survey question, or demographic information acquired from a third party by reference to a third party tracking cookie on the browser of the user, the web page type or section of the website the user is visiting, for example, a homepage, a politics section, an entertainment section, etc. The content access management application allows a media content owner to maintain full control over when and how often the first media content is locked. For example, the media content owner decides that the first media content should be locked if the user arrives at the content hosting website from a referring uniform resource locator (URL) of, for example, XYZ.com. The decision is based on where a user came from prior to coming to a Maxim site exemplarily illustrated in FIG. 6. The user may have come, for example, via a link pasted on a social networking platform, or via a search result on the Google search engine. In another example, the media content owner decides that the first media content should be locked if a web page belongs to a political section of the website, but not if the page belongs to a celebrity news section of the website. In an embodiment, the media content owner decides the parts of the media content to be hidden or visible to the user, that is, the media content owner can choose to lock the media content partially or completely. For example, the media content owner may decide, in case of a web page containing a written article, that the first paragraph of the article will not be locked, but the remaining section of the article will be locked.

The content access management application creates, for example, a locking media content object based on the decision criteria received from the media content owner and inserts the locking media content object to lock the first media content as exemplarily illustrated in FIG. 6. The locking media content object comprises second media content with an access condition that defines one or more engagement tasks to be completed to unlock the first media content. In an embodiment, the content access management application enables the user to choose and select the second media content, for example, an advertisement from a list of advertisements presented to the user. In another embodiment, the content access management application requires the user to confirm full attention to the second media content, for example, a video advertisement. The content access management application requires the user to meet the access condition by completing one or more engagement tasks, for example, by completing a challenge response, selecting and listening to an audio clip, answering survey questions, completing tasks such as counting a number of images, solving a puzzle, sharing information with social media contacts such as contacts on Twitter® of Twitter Inc., etc. As exemplarily illustrated in FIG. 6, the content access management application may request the user to view through a short video to earn a 72-hour free pass to a website. The user will therefore obtain the 72-hour free pass to the website on viewing the short video. The content access management application performs a leave behind operation when the user completes the engagement task associated with the second media content in the locking media content object to unlock the first media content.

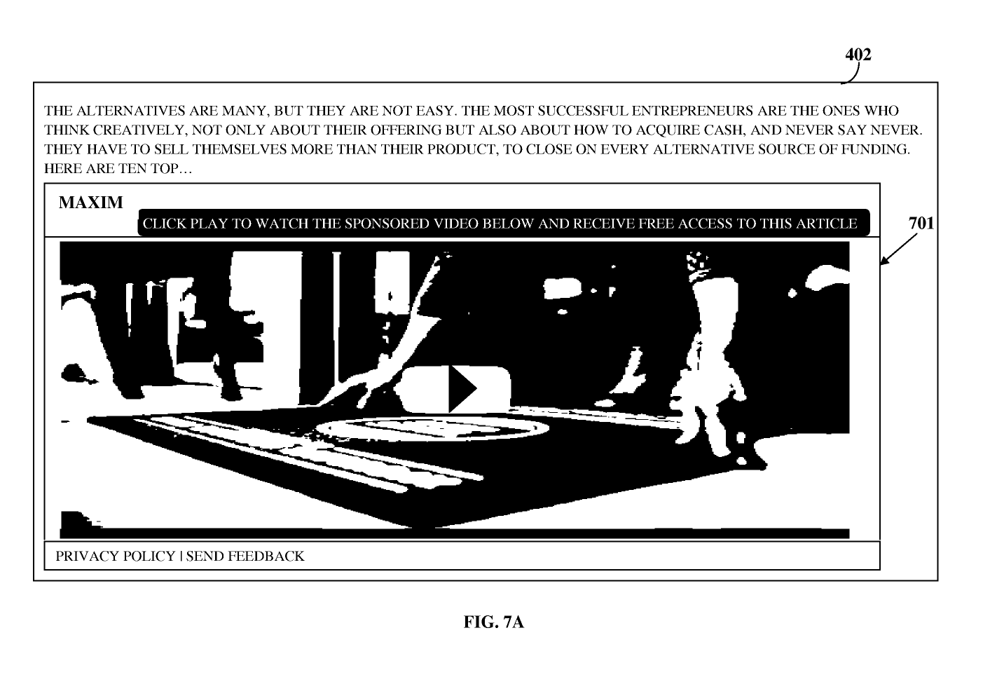

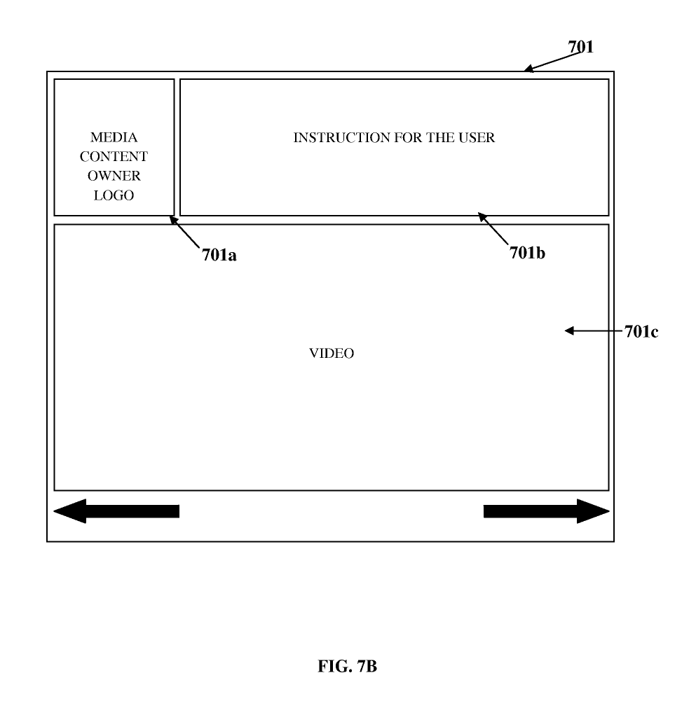

FIGS. 7A-7B exemplarily illustrate screenshots of a content display interface 402, showing a dynamic media content object 701, for example, an advertisement dynamically inserted into a section of the content display interface 402. The content access management application creates an advertisement inventory on the content display interface 402, for example, a web page of a website, adjacent to contextually relevant first media content, for example, editorial content comprising article pages and photo galleries. The content access management application hides the editorial content and prompts users to watch a video advertisement to gain access to the editorial content. Once playback of the video advertisement is complete, the dynamic media content object 701 having the video advertisement is removed, and the editorial content reappears on the web page. The content access management application does not require the web page to have an in-page video player for video content to run after the playback of the video advertisement, as is typically the case for delivery of online video advertisements, since the content access management application exists outside of typical in-page video players, for example, Brightcove® of Brightcove, Inc., Ooyala® of Ooyala, Inc., JW Player® of LongTail Ad Solutions, Inc., or Flowplayer of Flowplayer Ltd. The content access management application is deployed on the website.

FIG. 7A exemplarily illustrates a dynamic media content object 701 inserted over an article on a website. The content access management application truncates the article and renders the dynamic media content object 701 with a video player within a text body of the article. The dynamic media content object 701 created by the content access management application comprises configurable elements 701a, 701b, and 701c, which allow customization of the dynamic media content object 701 on each web page of the website as exemplarily illustrated in FIG. 7B. The content access management application allows media content owners to customize the configurable elements 701a, 701b, and 701c comprising, for example, an editorial message 701b with instructions for the user, a publisher or media content owner logo 701a, and the width of an advertisement 701c contained in the dynamic media content object 701. The content access management application allows the media content owner to preface the advertisement placement with a customized editorial message 701b that enables the user to understand the value exchange terms. For example, the media content owner can input a message 701b that reads: “Watch the following sponsored video to receive free access to this article” as exemplarily illustrated in FIG. 7A, or “Watch the following sponsored video to receive access to X articles”, or “Watch the following sponsored video to receive a free one day pass to content on this website”. The media content owner can add the logo 701a of the website or a network logo in the customizable dynamic media content object 701. The content access management application also allows a media content owner to adjust the width of a video player to fit the width of the content section by specifying a unit width.

In an embodiment, the content access management application runs with default settings during an initial calibration period. The length of the calibration period will depend on the volume of daily traffic on the website. The media content owner can monitor performance and optimize lock settings after completion of the calibration period. In another embodiment, the content access management application provides media content owners with granular control over which web pages are locked, for whom they are locked, and how often they are locked. For example, as a default setting, the content access management application displays a dynamic media content object on the first page view of each new session for each visitor or user to the website. In this example, a new session begins when a new visitor or user arrives on the website or when a user returns to the website after about 30 minutes of inactivity. In another embodiment, the content access management application provides metered access, that is, the content access management application allows the media content owner to specify how many unlocked articles a user should be able to view after they have completed watching the second media content on the website. The content access management application locks the web pages after the free page views have been consumed by the user. The media content owners can also provide users with uninterrupted access for any time period, for example, 24 hours after the users have watched a preset amount of second media content. For example, applying a frequency cap of 2/24 ensures that users view a maximum of two advertisements per day. In another example, the media content owner can disable web page locking for users arriving to the website from a list of referral sources. These users will not be shown any second media content. For example, the media content owner can disable the dynamic media content objects for direct traffic, that is, most loyal traffic. Conversely, in another example, the content access management application allows media content owners to monetize social traffic more aggressively than other sources. In an embodiment, the content access management application further provides an asynchronous mode setting that can be used, for example, to lock photo gallery pages after the user has viewed a certain number of photographs.

FIG. 8 exemplarily illustrates a graphical representation showing a relationship between user attention and engagement with second media content and access to first media content determined by the content access management application for a particular user. The content access management application allows a user to access the first media content based on time spent with second media content as payment for accessing the first media content and services. If the user pays attention to the second media content and completes a required set of engagement tasks defined in an access condition of a dynamic media content object, then the content access management application provides time based access to the first media content. For example, if the user spends about 30 seconds with the second media content, then the content access management application provides a 24 hour pass to the first media content. In another example, if the user spends about 90 seconds with the second media content, then the content access management application provides a 1 month pass to the first media content as exemplarily illustrated in FIG. 8.

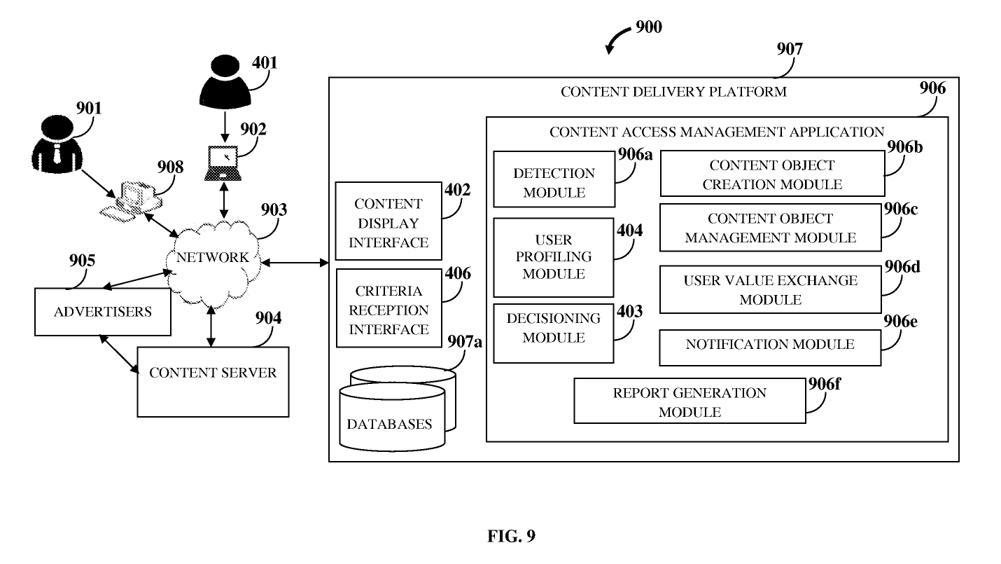

FIG. 9 exemplarily illustrates a computer implemented system 900 for controlling grant of access to first media content hosted on the content delivery platform 907. The computer implemented system 900 disclosed herein comprises a content access management application 906, a non-transitory computer readable storage medium that stores the content access management application 906, and at least one processor communicatively coupled to the non-transitory computer readable storage medium. As used herein, the term “non-transitory computer readable storage medium” refers to all computer readable media, for example, non-volatile media such as optical discs or magnetic disks, volatile media such as a register memory, a processor cache, etc., and transmission media such as wires that constitute a system bus coupled to the processor, except for a transitory, propagating signal. The processor is configured to execute modules 906a, 906b, 906c, 906d, 906e, 906f, 403, 404, etc., of the content access management application 906. In an embodiment, the content access management application 906 is deployed on the content delivery platform 907. In an embodiment, the content delivery platform 907 is implemented as a website or a web based platform hosted on a server or a network of servers. The content delivery platform 907 that hosts the content access management application 906 is accessible to one or more users 401 via user devices 902, for example, personal computers, laptops, tablet computing devices, smart phones, etc., and to one or more media content owners 901 via media content owner devices 908, for example, personal computers, laptops, tablet computing devices, smart phones, etc., over a network 903, for example, the internet, a network that implements Wi-Fi® of the Wireless Ethernet Compatibility Alliance, Inc., a mobile communication network, etc. The content access management application 906 is accessible through multiple browsers, for example, Internet Explorer® (IE) 7, IE 8, and IE 9 of Microsoft Corporation, Mozilla® Firefox® of Mozilla Foundation, Safari® of Apple Inc., Chrome of Google, Inc., etc., and is compatible with technologies, for example, hypertext markup language 5 (HTML5), etc. The content delivery platform 907 comprises one or more databases 907a for storing session data, decision criteria, user value scores, first media content, second media content, dynamic media content objects, user profiling information, audience profiling information, reports, etc.

The content access management application 906 comprises the modules 902a, 902b, 902c, 902d, 902e, 906f, 403, 404, etc., executable by the processor for controlling grant of access to the first media content hosted on the content delivery platform 907. The content access management application 906 comprises a detection module 906a, the user profiling module 404, the decisioning module 403, a content object creation module 906b, a content object management module 906c, a user value exchange module 906d, a notification module 906e, and a report generation module 906f. The content delivery platform 907 further hosts the content display interface 402 such a web page of a website hosted by the content delivery platform 907, and the criteria reception interface 406. The detection module 906a detects a user attempt to access the first media content on the content display interface 402. The user profiling module 404 dynamically analyzes user characteristics on detection of the user attempt to access the first media content. In an embodiment, the user profiling module 404 assigns user value scores to each of the users 401 based on offer availability, that is, an availability of advertisers 905 that want to sponsor each user 401 and the premium that the advertisers 905 are willing to pay to display the second media content to each user 401 based on demographic information obtained from prior usage of the content delivery platform 907. The user profiling module 404 determines the user value which is affected by user characteristics and offer availability. The user value exchange module 906d determines a value exchange between the users 401 and the media content owner 901 based on the user value scores. The user profiling module 404 further continuously analyzes engagement data of the content delivery platform 907 to determine monetization strategies for optimizing revenue generation and dynamic creation of one or more dynamic media content objects, and promoting desired user behavior on the content delivery platform 907.

The decisioning module 403 receives decision criteria, for example, one or more of preset rules, preset user segments, preset content segments, preset segment optimization goals, etc., via the criteria reception interface 406 provided by the content access management application 906. The decisioning module 403 generates monetization strategies for each user 401 using the analyzed user characteristics and one or more of the received decision criteria for determining a type of the first media content to be locked for each user 401, when the first media content is locked for each user 401, how frequently the first media content is locked for each user 401, and a type of lock mechanism to be used during each attempt to lock the first media content for each user 401. The decisioning module 403 further processes multiple inputs comprising the decision criteria received via the criteria reception interface 406 and the user characteristics for generating the monetization strategies.

The content object creation module 906b dynamically creates one or more dynamic media content objects comprising the second media content based on the analyzed user characteristics and one or more of the received decision criteria. Each dynamic media content object is configured as a locking media content object with an access condition or a non-locking media content object for controlling grant of access to the first media content. The locking media content object provides a preview of the first media content based on a content type of the first media content. The content object management module 906c dynamically inserts the dynamically created dynamic media content objects into one or more sections of the content display interface 402 based on the analyzed user characteristics and one or more of the received decision criteria. The notification module 906e generates and renders notifications with instructions during the dynamic insertion of the dynamically created dynamic media content objects into one or more sections of the content display interface 402. The content object management module 906c either restricts access to the first media content displayed on the content display interface 402 until the access condition is met or grants access to the first media content while displaying the second media content based on the type of dynamic media content object inserted on the content display interface 402. In an embodiment, each of the dynamic media content objects communicates with a content server 904 via the network 903 for loading and displaying the second media content available from multiple advertisers 905.

The content object management module 906c locks the first media content based on the access condition, renders the second media content on the content display interface 402, and unlocks the first media content when the access condition is met. The access condition defines one or more engagement tasks with the second media content to be completed by a user 401 as disclosed in the detailed description of FIG. 1A. In an embodiment, the content object management module 906c locks the first media content at a time instant when a user 401 accesses the content display interface 402. In another embodiment, the content object management module 906c locks the first media content after a user 401 performs a predefined set of actions on the content display interface 402. In another embodiment, the content object management module 906c dynamically inserts another dynamically created dynamic media content object into one or more sections of the content display interface 402 after the access condition contained in a previously inserted dynamic media content object is met. In another embodiment, the content object management module 906c grants time based access of the first media content to a user 401 based on time spent by the user 401 in engaging with the second media content. The report generation module 906f generates reports pertaining to, for example, one or more of revenue generated, targets achieved, frequency of locking of the first media content, and other information requested by the media content owner 901. The generated reports are stored in the databases 907a and are accessible by the media content owner 901 via the content display interface 402.

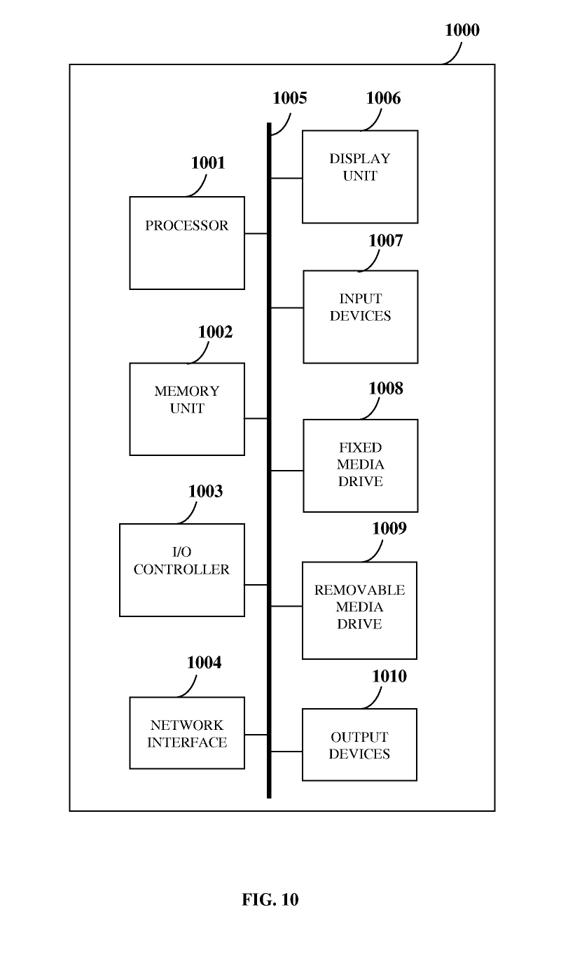

FIG. 10 exemplarily illustrates the architecture of a computer system 1000 employed by the content delivery platform 907, exemplarily illustrated in FIG. 9, for controlling grant of access to first media content hosted on the content delivery platform 907. The content delivery platform 907 of the computer implemented system 900 exemplarily illustrated in FIG. 9 employs the architecture of the computer system 1000 exemplarily illustrated in FIG. 10. The computer system 1000 is programmable using a high level computer programming language. The computer system 1000 may be implemented using programmed and purposeful hardware. The content delivery platform 907 hosting the content access management application 906 communicates with user devices 902 of each of the users 401, and media content owner devices 908 of each of the media content owners 901. The users 401 are, for example, viewers, web surfers, etc., registered with the content delivery platform 907 and who access the content delivery platform 907 via the network 903, for example, a short range network or a long range network.

The computer system 1000 comprises, for example, a processor 1001, a non-transitory computer readable storage medium such as a memory unit 1002 for storing programs and data, an input/output (I/O) controller 1003, a network interface 1004, a data bus 1005, a display unit 1006, input devices 1007, a fixed media drive 1008, a removable media drive 1009 for receiving removable media, output devices 1010, etc. The processor 1001 refers to any one or more microprocessors, central processing unit (CPU) devices, finite state machines, computers, microcontrollers, digital signal processors, logic, a logic device, an electronic circuit, an application specific integrated circuit (ASIC), a field-programmable gate array (FPGA), a chip, etc., or any combination thereof, capable of executing computer programs or a series of commands, instructions, or state transitions. The processor 1001 may also be implemented as a processor set comprising, for example, a general purpose microprocessor and a math or graphics co-processor. The processor 1001 is selected, for example, from the Intel® processors such as the Itanium® microprocessor or the Pentium® processors, Advanced Micro Devices (AMD®) processors such as the Athlon® processor, UltraSPARC® processors, microSPARC™ processors, hp® processors, International Business Machines (IBM®) processors such as the PowerPC® microprocessor, the MIPS° reduced instruction set computer (RISC) processor of MIPS Technologies, Inc., RISC based computer processors of ARM Holdings, Motorola® processors, Qualcomm® processors, etc. The content delivery platform 907 disclosed herein is not limited to a computer system 1000 employing a processor 1001. The computer system 1000 may also employ a controller or a microcontroller. The processor 1001 executes the modules, for example, 906a, 906b, 906c, 906d, 906e, 906f, 403, 404, etc., of the content access management application 906 hosted by the content delivery platform 907.

The memory unit 1002 is used for storing programs, applications, and data. For example, the detection module 906a, the user profiling module 404, the decisioning module 403, the content object creation module 906b, the content object management module 906c, the user value exchange module 906d, the notification module 906e, the report generation module 906f, etc., of the content access management application 906 are stored in the memory unit 1002 of the computer system 1000. The memory unit 1002 is, for example, a random access memory (RAM) or another type of dynamic storage device that stores information and instructions for execution by the processor 1001. The memory unit 1002 also stores temporary variables and other intermediate information used during execution of the instructions by the processor 1001. The computer system 1000 further comprises a read only memory (ROM) or another type of static storage device that stores static information and instructions for the processor 1001.

The network interface 1004 enables connection of the computer system 1000 to the network 903. For example, the content delivery platform 907 hosting the content access management application 906 connects to the network 903 via the network interface 1004. In an embodiment, the network interface 1004 is provided as an interface card also referred to as a line card. The network interface 1004 comprises, for example, one or more of an infrared (IR) interface, an interface implementing Wi-Fi® of the Wireless Ethernet Compatibility Alliance, Inc., a universal serial bus (USB) interface, a FireWire® interface of Apple, Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, and Ethernet communication interfaces, asynchronous transfer mode (ATM) interfaces, a high speed serial interface (HSSI), a fiber distributed data interface (FDDI), interfaces based on transmission control protocol (TCP)/internet protocol (IP), interfaces based on wireless communications technology such as satellite technology, radio frequency (RF) technology, near field communication, etc. The I/O controller 1003 controls input actions and output actions performed by the content delivery platform 907. The data bus 1005 permits communications between the modules, for example, 906a, 906b, 906c, 906d, 906e, 906f, 403, 404, etc., of the content access management application 906.

The display unit 1006 displays information, etc., for allowing the media content owner 901 to set the decision criteria such as rules, preferences, etc. The display unit 1006 comprises, for example, a liquid crystal display, a plasma display, an organic light emitting diode (OLED) based display, etc. The input devices 1007 are used for inputting data, for example, the raw session data into the computer system 1000. The input devices 1007 are, for example, a keyboard such as an alphanumeric keyboard, a microphone, a joystick, a pointing device such as a computer mouse, a touch pad, a light pen, a physical button, a touch sensitive display device, a track ball, a pointing stick, any device capable of sensing a tactile input, etc.

Computer applications and programs are used for operating the computer system 1000. The programs are loaded onto the fixed media drive 1008 and into the memory unit 1002 of the computer system 1000 via the removable media drive 1009. In an embodiment, the computer applications and programs may be loaded directly via the network 903. Computer applications and programs are executed by double clicking a related icon displayed on the display unit 1006 using one of the input devices 1007. The output devices 1010 output the results of operations performed by the content delivery platform 907. For example, the content delivery platform 907 displays the generated reports using the output devices 1010.

The processor 1001 executes an operating system, for example, the Linux® operating system, the Unix® operating system, any version of the Microsoft® Windows® operating system, the Mac OS of Apple Inc., the IBM® OS/2, VxWorks® of Wind River Systems, inc., QNX Neutrino® developed by QNX Software Systems Ltd., the Palm OS®, the Solaris operating system developed by Sun Microsystems, Inc., the Android operating system, the Windows Phone® operating system of Microsoft Corporation, the BlackBerry® operating system of Research in Motion Limited, the iOS operating system of Apple Inc., the Symbian® operating system of Symbian Foundation Limited, etc. The computer system 1000 employs the operating system for performing multiple tasks. The operating system is responsible for management and coordination of activities and sharing of resources of the computer system 1000. The operating system further manages security of the computer system 1000, peripheral devices connected to the computer system 1000, and network connections. The operating system employed on the computer system 1000 recognizes, for example, inputs provided by the media content owners 901 using one of the input devices 1007, the output display, files, and directories stored locally on the fixed media drive 1008, for example, a hard drive. The operating system on the computer system 1000 executes different programs using the processor 1001. The processor 1001 and the operating system together define a computer platform for which application programs in high level programming languages are written.

The processor 1001 retrieves instructions for executing the modules, for example, 906a, 906b, 906c, 906d, 906e, 906f, 403, 404, etc., of the content access management application 906 from the memory unit 1002. A program counter determines the location of the instructions in the memory unit 1002. The program counter stores a number that identifies the current position in the program of each of the modules, for example, 906a, 906b, 906c, 906d, 906e, 906f, 403, 404, etc., of the content access management application 906. The instructions fetched by the processor 1001 from the memory unit 1002 after being processed are decoded. The instructions are stored in an instruction register in the processor 1001. After processing and decoding, the processor 1001 executes the instructions. For example, the detection module 906a defines instructions for detecting a user attempt to access the first media content on the content display interface 402. The user profiling module 404 defines instructions for dynamically analyzing user characteristics on detection of the user attempt to access the first media content. In an embodiment, the user profiling module 404 defines instructions for assigning user value scores to each user 401 based on offer availability, that is, an availability of advertisers 905 that want to sponsor each user 401 and the premium that the advertisers 905 are willing to pay to display the second media content to each user 401 based on demographic information obtained from prior usage of the content delivery platform. The user value exchange module 906d defines instructions for determining a value exchange between the users 401 and the media content owner 901 based on the user value scores. The user profiling module 404 defines instructions for continuously analyzing engagement data of the content delivery platform 907 to determine monetization strategies for optimizing revenue generation and the dynamic creation of one or more dynamic media content objects, and promoting desired user behavior on the content delivery platform 907.

The decisioning module 403 defines instructions for receiving decision criteria via the criteria reception interface 406 provided by the content access management application 906. The decisioning module 403 further defines instructions for generating monetization strategies for each user 401 using the analyzed user characteristics and one or more of the received decision criteria for determining a type of the first media content to be locked for each user 401, when the first media content is locked for each user 401, how frequently the first media content is locked for each user 401, and a type of lock mechanism to be used during each attempt to lock the first media content for each user 401. The decisioning module 403 further defines instructions for processing multiple inputs comprising the decision criteria received via the criteria reception interface 406 and the user characteristics for generating the monetization strategies.

The content object creation module 906b defines instructions for dynamically creating one or more dynamic media content objects based on the analyzed user characteristics and one or more of the received decision criteria. The content object management module 906c defines instructions for dynamically inserting the dynamically created dynamic media content objects into one or more sections of the content display interface 402 based on the analyzed user characteristics and one or more of the received decision criteria. The notification module 906e defines instructions for generating and rendering notifications with instructions during the dynamic insertion of the dynamically created dynamic media content objects into one or more sections of the content display interface 402. The content object management module 906c further defines instructions for restricting access to the first media content displayed on the content display interface 402 until the access condition is met or for granting access to the first media content while displaying the second media content based on the type of dynamic media content object inserted on the content display interface 402. The content object management module 906c further defines instructions for locking the first media content, rendering the second media content on the content display interface 402, and unlocking the first media content when the access condition is met. In an embodiment, the content object management module 906c defines instructions for locking the first media content at a time instant when a user 401 accesses the content display interface 402. In another embodiment, the content object management module 906c defines instructions for locking the first media content after a user 401 performs one or more of a predefined set of actions on the content display interface 402. In another embodiment, the content object management module 906c defines instructions for dynamically inserting another dynamically created dynamic media content object into one or more sections of the content display interface 402 after the access condition associated with a previously inserted dynamic media content object is met. In another embodiment, the content object management module 906c further defines instructions for providing a preview of the first media content based on a content type of the first media content. In another embodiment, the content object management module 906c further defines instructions for granting time based access to the first media content based on time spent by the user 401 in engaging with the second media content. The report generation module 906f defines instructions for generating reports pertaining to, for example, one or more of revenue generated, targets achieved, frequency of locking of the first media content, and other information requested by the media content owner 901. The generated reports are accessible by the media content owner 901 via the content display interface 402.

The processor 1001 of the computer system 1000 employed by the content delivery platform 907 retrieves the instructions defined by the detection module 906a, the user profiling module 404, the decisioning module 403, the content object creation module 906b, the content object management module 906c, the user value exchange module 906d, the notification module 906e, and the report generation module 906f, and executes the instructions, thereby performing one or more processes defined by those instructions.

At the time of execution, the instructions stored in the instruction register are examined to determine operations to be performed. The processor 1001 then performs the specified operations. The operations comprise arithmetic operations and logic operations. The operating system performs multiple routines for performing a number of tasks required to assign the input devices 1007, the output devices 1010, and memory for execution of the modules, for example, 906a, 906b, 906c, 906d, 906e, 906f, 403, 404, etc., of the content delivery platform 907. The tasks performed by the operating system comprise, for example, assigning memory to the modules, for example, 906a, 906b, 906c, 906d, 906e, 906f, 403, 404, etc., of the content delivery platform 907, and to data used by the content delivery platform 907, moving data between the memory unit 1002 and disk units, and handling input/output operations. The operating system performs the tasks on request by the operations and after performing the tasks, the operating system transfers the execution control back to the processor 1001. The processor 1001 continues the execution to obtain one or more outputs. The outputs of the execution of the modules, for example, 906a, 906b, 906c, 906d, 906e, 906f, 403, 404, etc., of the content delivery platform 907 are displayed to the user 401 on the display unit 1006.

For purposes of illustration, the detailed description refers to the content delivery platform 907 being run locally on the computer system 1000; however the scope of the computer implemented method and system 900 disclosed herein is not limited to the content delivery platform 907 being run locally on the computer system 1000 via the operating system and the processor 1001, but may be extended to run remotely over the network 903 by employing a web browser and a remote server, a mobile phone, or other electronic devices. One or more portions of the computer system 1000 may be distributed across one or more computer systems (not shown) coupled to the network 903.

Disclosed herein is also a computer program product comprising a non-transitory computer readable storage medium that stores computer program codes comprising instructions executable by at least one processor 1001 for controlling grant of access to the first media content hosted on the content delivery platform 907. The computer program product comprises a first computer program code for detecting a user attempt to access the first media content on the content display interface 402; a second computer program code for dynamically analyzing user characteristics on detection of the user attempt to access the first media content; a third computer program code for receiving decision criteria via the criteria reception interface 406; a fourth computer program code for dynamically creating one or more dynamic media content objects based on the analyzed user characteristics and one or more of the received decision criteria; and a fifth computer program code for dynamically inserting the dynamically created dynamic media content objects into one or more sections of the content display interface 402 based on the analyzed user characteristics and one or more of the received decision criteria. The fifth computer program code comprises a sixth computer program code for restricting access to the first media content displayed on the content display interface 402 until the access condition is met and a seventh computer program code for granting access to the first media content while displaying the second media content. The computer program product disclosed herein further comprises an eighth computer program code for locking the first media content, rendering the second media content on the content display interface 402, and unlocking the first media content when the access condition is met.

The computer program product disclosed herein further comprises one or more additional computer program codes for performing additional steps that may be required and contemplated for controlling grant of access to the first media content hosted on the content delivery platform 907. In an embodiment, a single piece of computer program code comprising computer executable instructions performs one or more steps of the computer implemented method disclosed herein for controlling grant of access to the first media content hosted on the content delivery platform 907. The computer program codes comprising computer executable instructions are embodied on the non-transitory computer readable storage medium. The processor 1001 of the computer system 1000 retrieves these computer executable instructions and executes them. When the computer executable instructions are executed by the processor 1001, the computer executable instructions cause the processor 1001 to perform the steps of the computer implemented method for controlling grant of access to the first media content hosted on the content delivery platform 907.

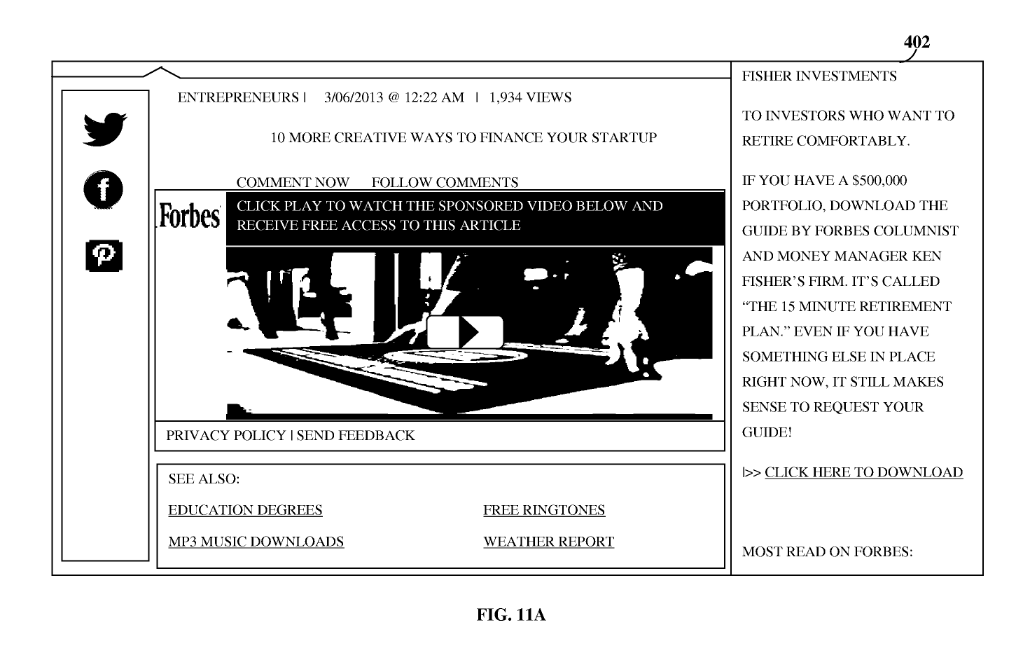

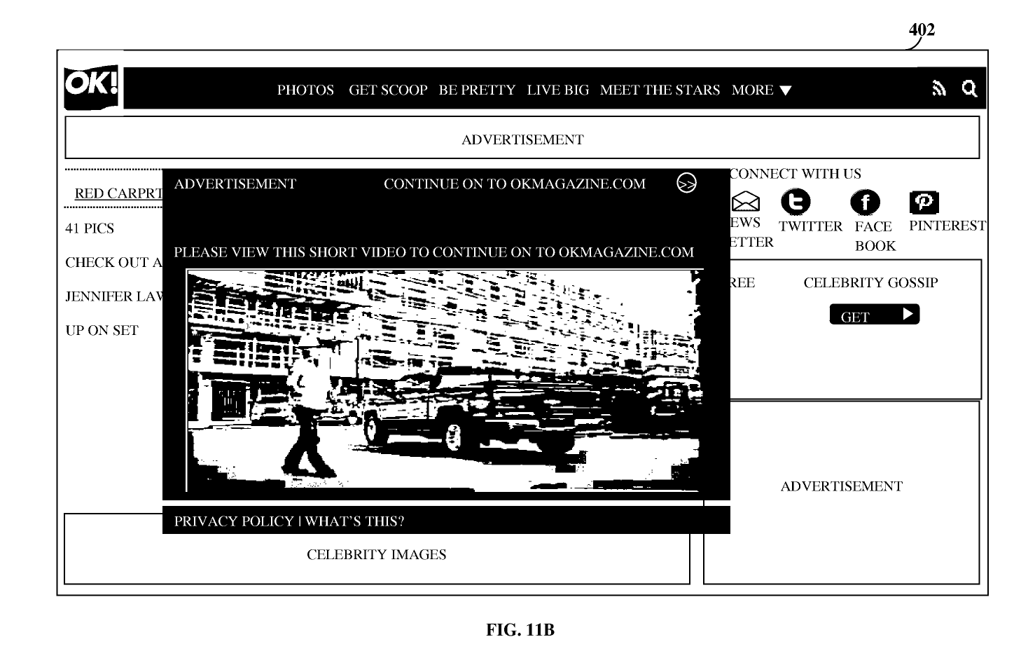

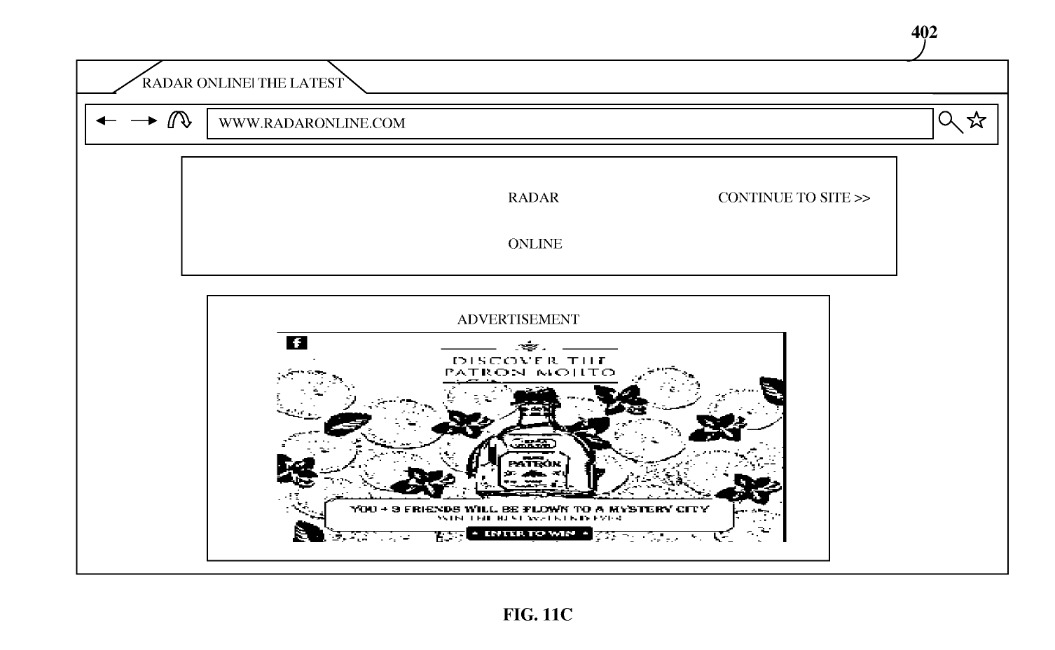

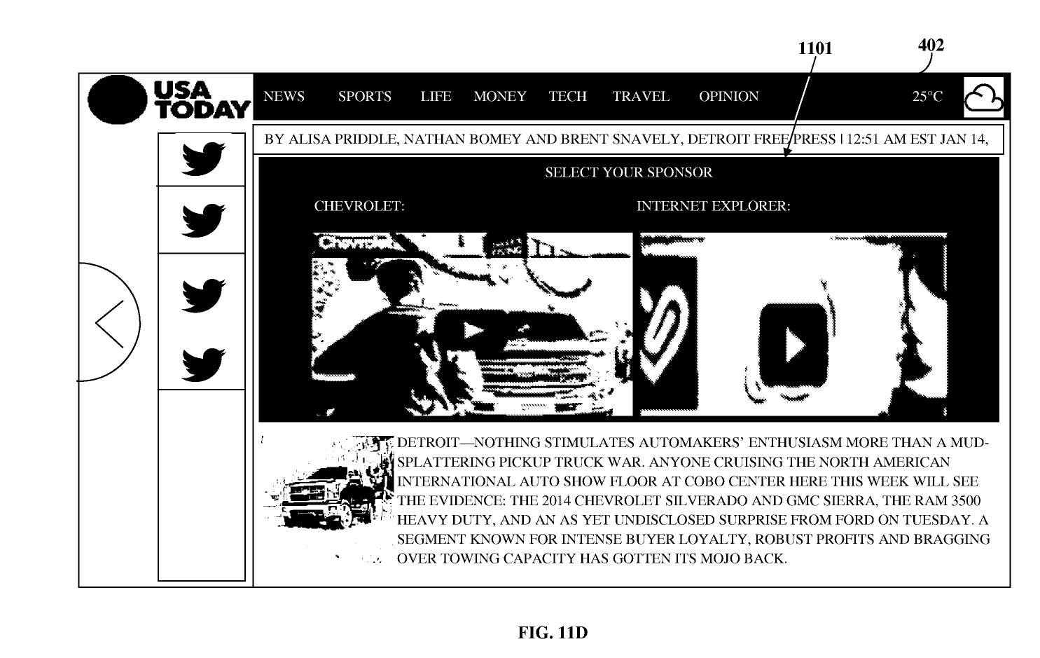

FIGS. 11A-11D exemplarily illustrate screenshots of the content display interface 402 of the content delivery platform 907, exemplarily illustrated in FIG. 9, showing different locking mechanisms and a non-locking media content object employed by the content access management application 906 exemplarily illustrated in FIG. 9. FIG. 11A exemplarily illustrates a screenshot of the content display interface 402, herein referred to as a “web page”, showing a content replacement mechanism employed by the content access management application 906. When the content access management application 906 employs the content locking mechanism, the content access management application 906 first reads the hyper text markup language (HTML) source code of the web page to be locked. The content access management application 906 then parses the structured HTML source code to identify sections of the web page that contain the editorial body of the web page. The editorial body comprises content that is unique on the web page, for example, editorial text, photo galleries, videos, and other rich media content. The editorial body further comprises the first media content that the user wants to consume on that particular web page. The editorial body does not include elements, for example, a navigation bar, a sidebar, a header and a footer, etc., that are present throughout the website.

The content access management application 906 allows the media content owner 901 exemplarily illustrated in FIG. 9, to add predefined HTML markup to elements on the web page to make up the editorial body of the web page. If this predefined HTML markup is not found on the web page, the content access management application 906 compares the web page with other web pages on the website to determine sections that are unique and therefore likely to be the editorial body of the web page. The content access management application 906 removes those HTML elements from the web page that make up the editorial body and stores the HTML elements in a memory unit in such a way that the editorial body can be reconstructed on the web page at any time. If the editorial body comprises textual content, the content access management application 906 retains a certain portion of text in place so that the user can view a preview of the first media content. The content access management application 906 creates a dynamic media content object or a dynamic placement and inserts the dynamic media content object into that section of the website, where the editorial body was previously located. Once the sponsored content has been loaded and a predefined engagement task has been completed, that is, when the access condition has been met, the content access management application 906 removes the dynamic media content object from the web page and reconstructs the editorial body on the web page.

FIG. 11B exemplarily illustrates a screenshot of the content display interface 402, herein referred to as a “web page”, showing a content obscuration mechanism employed by the content access management application 906. When the content access management application 906 employs the content obscuration mechanism, the content access management application 906 obscures the first media content on the web page by creating a modal dynamic media content object or an advertisement placement, inserting the modal dynamic media content object into the web page, and positioning the modal dynamic media content object over the web page content in such a way that the editorial body is fully or partially invisible until the modal is removed from the web page. The content access management application 906 loads the sponsored content into the modal dynamic media content object. Once a predefined engagement task has been completed, that is, when the access condition has been met, the content access management application 906 removes the modal dynamic media content object from the web page and then displays the editorial body.

FIG. 11C exemplarily illustrates a screenshot of the content display interface 402, herein referred to as a “web page”, showing a content gating mechanism employed by the content access management application 906. When the content access management application 906 employs the content gating mechanism, the content access management application 906 reads the hyper text markup language (HTML) source code of the web page to be locked. The content access management application 906 stores the HTML source code in a memory unit and removes all HTML elements from the web page. The content access management application 906 creates a dynamic media content object and injects the dynamic media content object into the web page. Once the content access management application 906 loads the sponsored content into the dynamic media content object and a predefined engagement task with the sponsored content has been completed, that is, when the access condition has been met, the content access management application 906 displays a hyperlink that allows the user to access and view the first media content. When the user clicks on the hyperlink, the content access management application 906 removes the dynamic media content object from the web page and restores the original HTML source code of the web page.

FIG. 11D exemplarily illustrates a screenshot of the content display interface 402, herein referred to as a “web page”, showing a non-locking media content object 1101. The content access management application 906 creates and inserts non-locking media content objects 1101 into a web page based on the decision criteria. When such a non-locking media content object 1101 is inserted into the web page, the non-locking media content object 1101 does not obscure the first media content. The user can engage with the second media content in the non-locking media content object 1101 while accessing the first media content as exemplarily illustrated in FIG. 11D.

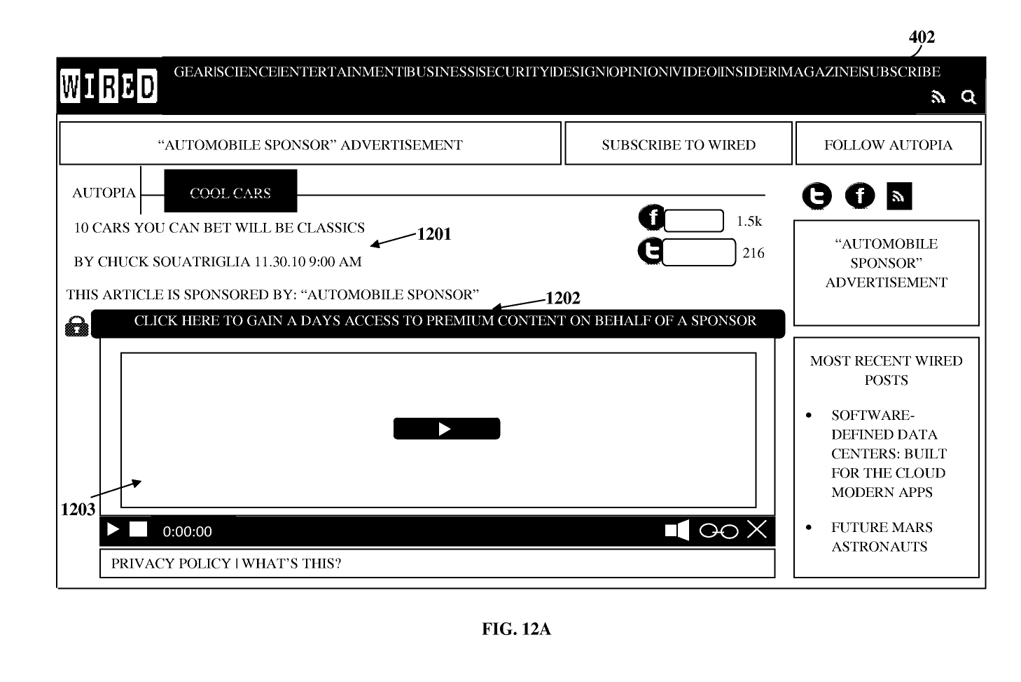

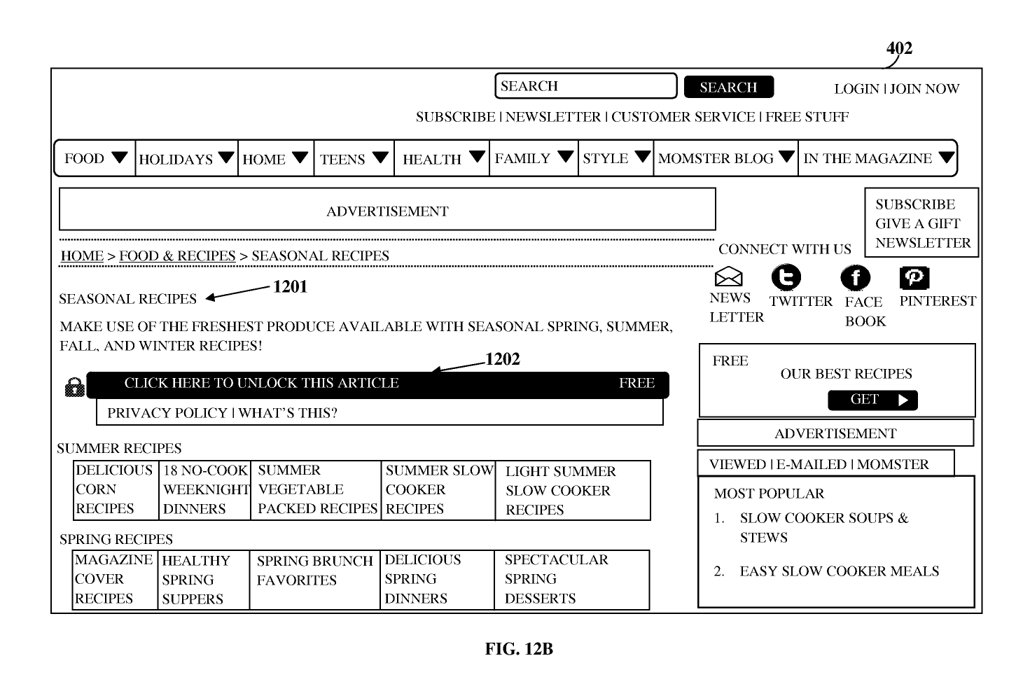

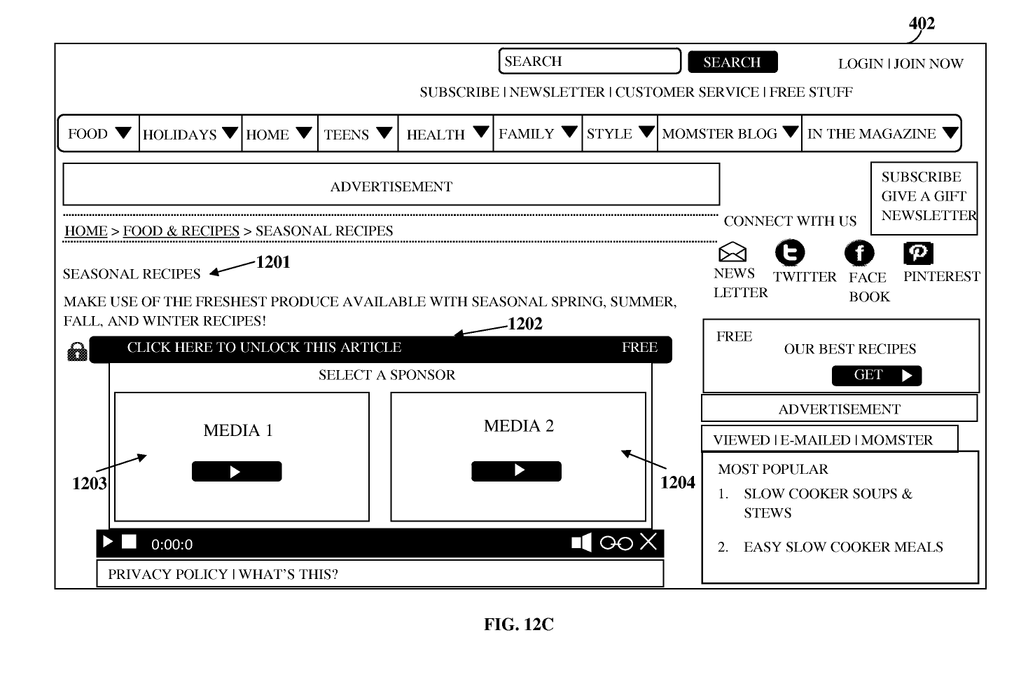

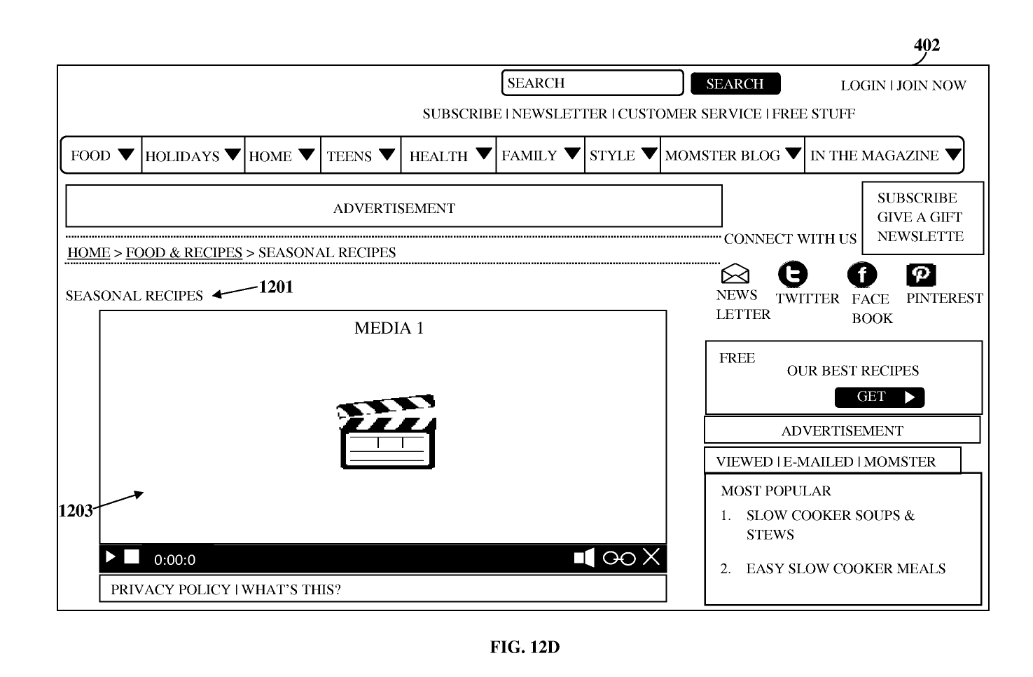

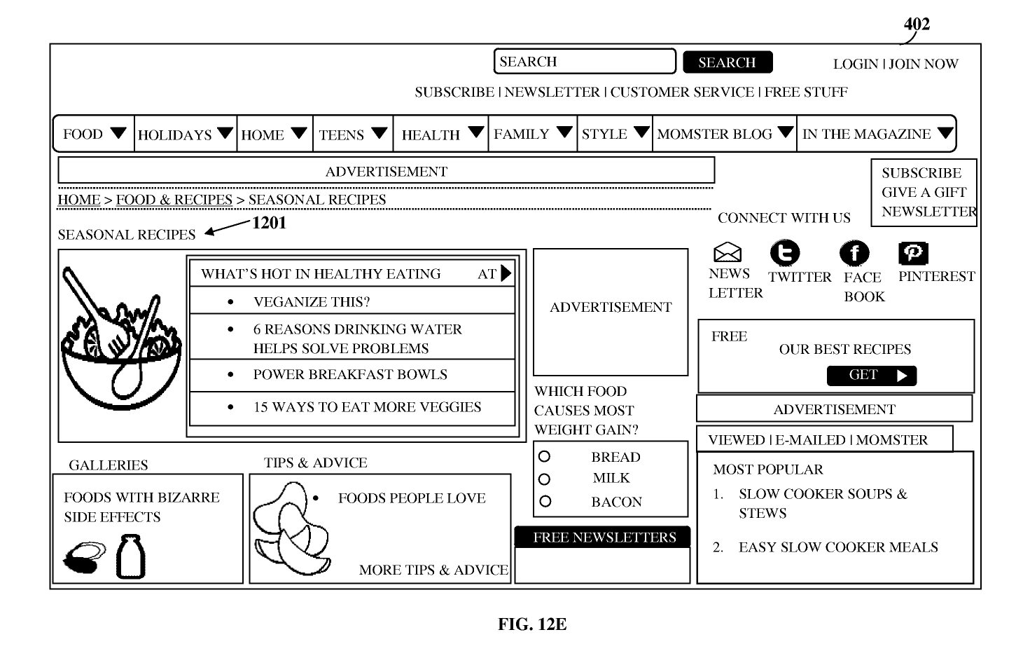

FIGS. 12A-12E exemplarily illustrate screenshots of the content display interface 402 of the content delivery platform 907 exemplarily illustrated in FIG. 9, with controlled grant of access to the first media content 1201 on the content display interface 402. The content access management application 906 exemplarily illustrated in FIG. 9, generates notifications with instructions during the dynamic insertion of the dynamically created dynamic media content objects into one or more sections of the content display interface 402. For example, the content access management application 906 displays a notification message 1202, for example, “Click here to gain access to a day's access to premium content on behalf of a sponsor” across the locked first media content 1201 about cars as exemplarily illustrated in FIG. 12A. In this example, the content access management application 906 renders a dynamic media content object or an advertisement placement 1203 comprising second media content such as a video advertisement over the first media content 1201 by hiding the first media content 1201. In another example, the content access management application 906 displays a notification message 1202, for example, “Click here to unlock this article” across the locked first media content 1201 about seasonal recipes as exemplarily illustrated in FIG. 12B. In this example, the content access management application 906 completely locks the first media content 1201. A user has to watch the video advertisement to unlock the first media content 1201. In an embodiment, the content access management application 906 provides the user an option to select from two advertisement placements 1203 and 1204 comprising the second media content, for example, a choice of two video clips when the user clicks on the notification message 1202, as exemplarily illustrated in FIG. 12C. Once the user selects the video he/she wishes to view, the content access management application 906 displays the advertisement placement 1203 or 1204 selected by the user as exemplarily illustrated in FIG. 12D. After the user completes a specified form of engagement with the advertisement placement 1203 or 1204, for example, by watching the video clip, the content access management application 906 unlocks and displays the first media content 1201. The unlocked first media content 1201 is exemplarily illustrated in FIG. 12E.

It will be readily apparent that the various methods, algorithms, and computer programs disclosed herein may be implemented on computer readable media appropriately programmed for computing devices. As used herein, the term “computer readable media” refers to non-transitory computer readable media that participate in providing data, for example, instructions that may be read by a computer, a processor or a similar device. Non-transitory computer readable media comprise all computer readable media, for example, non-volatile media, volatile media, and transmission media, except for a transitory, propagating signal. Non-volatile media comprise, for example, optical discs or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to a processor, etc. Common forms of computer readable media comprise, for example, a floppy disk, a flexible disk, a hard disk, magnetic tape, a laser disc, a Blu-ray Disc®, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

The computer programs that implement the methods and algorithms disclosed herein may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of programming languages that can be used comprise C, C++, C#, Java®, JavaScript®, Fortran, Ruby, Pascal, Perl®, Python®, Visual Basic®, hypertext preprocessor (PHP), Microsoft®.NET etc. Other object-oriented, functional, scripting, and/or logical programming languages may also be used. The computer program codes or software programs may be stored on or in one or more mediums as object code. Various aspects of the method and system disclosed herein may be implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. Various aspects of the method and system disclosed herein may be implemented as programmed elements, or non-programmed elements, or any suitable combination thereof. The computer program product disclosed herein comprises computer executable instructions embodied in a non-transitory computer readable storage medium, wherein the computer program product comprises one or more computer program codes for implementing the processes of various embodiments.

Where databases are described such as the databases 907a and the session data warehouse 301b, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment comprising one or more computers that are in communication with one or more devices via a network. The computers may communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, some examples of which are disclosed above, that are adapted to communicate with the computers. In an embodiment, each of the computers is equipped with a network communication device, for example, a network interface card, a modem, or other network connection device suitable for connecting to a network. Each of the computers and the devices executes an operating system, some examples of which are disclosed above. While the operating system may differ depending on the type of computer, the operating system will continue to provide the appropriate communications protocols to establish communication links with the network. Any number and type of machines may be in communication with the computers.

The present invention is not limited to a particular computer system platform, processor, operating system, or network. One or more aspects of the present invention may be distributed among one or more computer systems, for example, servers configured to provide one or more services to one or more client computers, or to perform a complete task in a distributed system. For example, one or more aspects of the present invention may be performed on a client-server system that comprises components distributed among one or more server systems that perform multiple functions according to various embodiments. These components comprise, for example, executable, intermediate, or interpreted code, which communicate over a network using a communication protocol. The present invention is not limited to be executable on any particular system or group of systems, and is not limited to any particular distributed architecture, network, or communication protocol.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

We claim:

1. A computer implemented method for controlling grant of access to first media content, comprising:
providing a content access management application executable by at least one processor configured to control said grant of said access to said first media content hosted on a content delivery platform;
detecting a user attempt to access said first media content on a content display interface by said content access management application;
dynamically analyzing user characteristics by said content access management application on said detection of said user attempt to access said first media content;
receiving decision criteria via a criteria reception interface provided by said content access management application;
dynamically creating one or more dynamic media content objects by said content access management application based on said analyzed user characteristics and one or more of said received decision criteria, wherein each of said dynamically created one or more dynamic media content objects comprises second media content, and wherein one or more of said dynamically created one or more dynamic media content objects are configured with an access condition for controlling said grant of said access to said first media content; and
dynamically inserting said dynamically created one or more dynamic media content objects into one or more sections of said content display interface by said content access management application based on said analyzed user characteristics and one or more of said received decision criteria, wherein each of said dynamically inserted one or more dynamic media content objects is configured to perform one of:
restricting said access to said first media content displayed on said content display interface until said access condition is met; and
granting said access to said first media content while displaying said second media content.

2. The computer implemented method of claim 1, wherein said each of said dynamically created one or more dynamic media content objects is configured as one of a locking media content object with said access condition, and a non-locking media content object.

3. The computer implemented method of claim 2, wherein said locking media content object is configured to provide a preview of said first media content based on a content type of said first media content.

4. The computer implemented method of claim 1, further comprising locking said first media content, rendering said second media content on said content display interface, and unlocking said first media content when said access condition is met, by said content access management application.

5. The computer implemented method of claim 1, wherein said access condition is configured to define one or more of a plurality of engagement tasks with said second media content to be completed.

6. The computer implemented method of claim 5, wherein said engagement tasks comprise completing a challenge response for confirming full attention to said second media content, selecting and listening to audio content, selecting and viewing multimedia content, answering survey questions, sharing information with social media contacts, answering a quiz correctly, completing a game, confirming attention paid to a media clip, downloading said second media content that is one of hosted on a content application server and hosted outside said content application server, downloading an application that is one of hosted on said content application server and hosted outside said content application server, creating a user profile on said content delivery platform, visiting another content display interface, liking an advertiser on a social networking platform through a like option, filling in a form, joining an electronic mailing list, solving a mathematical equation, making a payment through a payment mode, choosing to apply credits earned, and any combination thereof.

7. The computer implemented method of claim 1, wherein said decision criteria comprise one or more of preset rules, preset user segments, preset content segments, and preset segment optimization goals.

8. The computer implemented method of claim 1, further comprising locking said first media content by said content access management application at a time instant when a user accesses said content display interface.

9. The computer implemented method of claim 1, further comprising locking said first media content by said content access management application after a user performs one or more of a predefined set of actions on said content display interface.

10. The computer implemented method of claim 1, further comprising dynamically inserting another of said dynamically created one or more dynamic media content objects into said one or more sections of said content display interface by said content access management application after said access condition associated with a previous one of said dynamically created one or more dynamic media content objects is met.

11. The computer implemented method of claim 1, wherein said dynamic analysis of said user characteristics by said content access management application comprises assigning user value scores to each of a plurality of users based on an availability of advertisers that want to sponsor said each of said users and a premium that said advertisers are willing to pay to display said second media content to said each of said users based on demographic information obtained from prior usage of said content delivery platform.

12. The computer implemented method of claim 1, further comprising generating monetization strategies for each of a plurality of users by said content access management application using said analyzed user characteristics and one or more of said received decision criteria for determining a type of said first media content to be locked for said each of said users, when said first media content is locked for said each of said users, how frequently said first media content is locked for said each of said users, and a type of lock mechanism to be used during each attempt to lock said first media content for said each of said users.

13. The computer implemented method of claim 1, wherein said second media content comprises one or more of advertisements, games, videos, audio messages, and surveys.

14. The computer implemented method of claim 1, wherein said first media content comprises structured hypertext markup language content comprising static content and multimedia content.

15. The computer implemented method of claim 1, further comprising continuously analyzing engagement data of said content delivery platform by said content access management application to determine monetization strategies for optimizing revenue generation and said dynamic creation of said one or more dynamic media content objects, and promoting desired user behavior on said content delivery platform.

16. The computer implemented method of claim 1, wherein said each of said dynamically created one or more dynamic media content objects is further configured to communicate with a content server via a network for loading and displaying said second media content.

17. The computer implemented method of claim 1, further comprising generating and rendering notifications with instructions by said content access management application during said dynamic insertion of said dynamically created one or more dynamic media content objects into said one or more sections of said content display interface.

18. The computer implemented method of claim 1, further comprising generating reports pertaining to one or more of revenue generated, targets achieved, frequency of locking of said first media content, and information requested by a media content owner, by said content access management application.

19. The computer implemented method of claim 1, wherein said dynamic insertion of said dynamically created one or more dynamic media content objects into said one or more sections of said content display interface by said content access management application is performed by one or more of replacing said first media content with said dynamically created one or more dynamic media content objects, gating said first media content with said dynamically created one or more dynamic media content objects, and obscuring said first media content with said dynamically created one or more dynamic media content objects.

20. The computer implemented method of claim 1, further comprising granting time based access to said first media content by said content access management application based on time spent by a user in engaging with said second media content.

21. A computer implemented method for controlling grant of access to first media content, comprising:
providing a content access management application executable by at least one processor configured to control said grant of said access to said first media content hosted on a content delivery platform;
receiving decision criteria via a criteria reception interface provided by said content access management application;
determining whether, how, and when to lock said first media content by said content access management application based on one or more of said received decision criteria;
rendering second media content on a content display interface by said content access management application; and
unlocking said first media content and displaying said unlocked first media content by said content access management application on completion of a specified form of engagement with said second media content.

22. The computer implemented method of claim 21, wherein said decision criteria comprise one or more of preset rules, preset user segments, preset content segments, and preset segment optimization goals.

23. A computer implemented system for controlling grant of access to first media content, comprising:
a non-transitory computer readable storage medium configured to store a content access management application;
at least one processor communicatively coupled to said non-transitory computer readable storage medium, said at least one processor configured to execute said content access management application; and
said content access management application comprising:
a detection module configured to detect a user attempt to access said first media content on a content display interface;
a user profiling module configured to dynamically analyze user characteristics on said detection of said user attempt to access said first media content;
a decisioning module configured to receive decision criteria via a criteria reception interface provided by said content access management application;
a content object creation module configured to dynamically create one or more dynamic media content objects based on said analyzed user characteristics and one or more of said received decision criteria, wherein each of said dynamically created one or more dynamic media content objects comprises second media content, and wherein one or more of said dynamically created one or more dynamic media content objects are configured with an access condition for controlling said grant of said access to said first media content; and
a content object management module configured to dynamically insert said dynamically created one or more dynamic media content objects into one or more sections of said content display interface based on said analyzed user characteristics and one or more of said received decision criteria, wherein each of said dynamically inserted one or more dynamic media content objects is configured to perform one of:
restricting said access to said first media content displayed on said content display interface until said access condition is met; and
granting said access to said first media content while displaying said second media content.

24. The computer implemented system of claim 23, wherein said content object management module is further configured to lock said first media content, render said second media content on said content display interface, and unlock said first media content when said access condition is met.

25. The computer implemented system of claim 23, wherein said access condition is configured to define one or more of a plurality of engagement tasks with said second media content to be completed, wherein said engagement tasks comprise completing a challenge response for confirming full attention to said second media content, selecting and listening to audio content, selecting and viewing multimedia content, answering survey questions, sharing information with social media contacts, answering a quiz correctly, completing a game, confirming attention paid to a media clip, downloading said second media content that is one of hosted on a content application server and hosted outside said content application server, downloading an application that is one of hosted on said content application server and hosted outside said content application server, creating a user profile on said content delivery platform, visiting another content display interface, liking an advertiser on a social networking platform through a like option, filling in a form, joining an electronic mailing list, solving a mathematical equation, making a payment through a payment mode, choosing to apply credits earned, and any combination thereof.

26. The computer implemented system of claim 23, wherein said decision criteria comprise one or more of preset rules, preset user segments, preset content segments, and preset segment optimization goals.

27. The computer implemented system of claim 23, wherein said content object management module is further configured to lock said first media content at a time instant when a user accesses said content display interface.

28. The computer implemented system of claim 23, wherein said content object management module is further configured to lock said first media content after a user performs one or more of a predefined set of actions on said content display interface.

29. The computer implemented system of claim 23, wherein said content object management module is further configured to dynamically insert another of said dynamically created one or more dynamic media content objects into said one or more sections of said content display interface after said access condition associated with a previous one of said dynamically created one or more dynamic media content objects is met.

30. The computer implemented system of claim 23, wherein said one or more of said dynamically created one or more dynamic media content objects are configured to provide a preview of said first media content based on a content type of said first media content.

31. The computer implemented system of claim 23, wherein said user profiling module is further configured to assign user value scores to each of a plurality of users based on an availability of advertisers that want to sponsor said each of said users and a premium that said advertisers are willing to pay to display said second media content to said each of said users based on demographic information obtained from prior usage of said content delivery platform.

32. The computer implemented system of claim 23, wherein said decisioning module is further configured to generate monetization strategies for each of a plurality of users using said analyzed user characteristics and one or more of said received decision criteria for determining a type of said first media content to be locked for said each of said users, when said first media content is locked for said each of said users, how frequently said first media content is locked for said each of said users, and a type of lock mechanism to be used during each attempt to lock said first media content for said each of said users.

33. The computer implemented system of claim 23, wherein said second media content comprises one or more of advertisements, games, videos, audio messages, and surveys.

34. The computer implemented system of claim 23, wherein said first media content comprises structured hypertext markup language content comprising static content and multimedia content.

35. The computer implemented system of claim 23, wherein said user profiling module is further configured to continuously analyze engagement data of said content delivery platform to determine monetization strategies for optimizing revenue generation and said dynamic creation of said one or more dynamic media content objects, and promoting desired user behavior on said content delivery platform.

36. The computer implemented system of claim 23, wherein said each of said dynamically created one or more dynamic media content objects is further configured to communicate with a content server via a network for loading and displaying said second media content.

37. The computer implemented system of claim 23, wherein said content access management application further comprises a notification module configured to generate and render notifications with instructions during said dynamic insertion of said dynamically created one or more dynamic media content objects into said one or more sections of said content display interface.

38. The computer implemented system of claim 23, wherein said content access management application further comprises a report generation module configured to generate reports pertaining to one or more of revenue generated, targets achieved, frequency of locking of said first media content, and information requested by a media content owner.

39. A computer program product comprising a non-transitory computer readable storage medium, said non-transitory computer readable storage medium storing computer program codes that comprise instructions executable by at least one processor, said computer program codes comprising:
a first computer program code for detecting a user attempt to access first media content on a content display interface;
a second computer program code for dynamically analyzing user characteristics on said detection of said user attempt to access said first media content;
a third computer program code for receiving decision criteria via a criteria reception interface;
a fourth computer program code for dynamically creating one or more dynamic media content objects based on said analyzed user characteristics and one or more of said received decision criteria, wherein each of said dynamically created one or more dynamic media content objects comprises second media content, and wherein said each of said dynamically created one or more dynamic media content objects is configured as one of a locking media content object with an access condition, and a non-locking media content object for controlling grant of said access to said first media content; and
a fifth computer program code for dynamically inserting said dynamically created one or more dynamic media content objects into one or more sections of said content display interface based on said analyzed user characteristics and one or more of said received decision criteria, wherein said fifth computer program code comprises:
a sixth computer program code for restricting said access to said first media content displayed on said content display interface until said access condition is met; and
a seventh computer program code for granting said access to said first media content while displaying said second media content.

40. The computer program product of claim 39, wherein said computer program codes further comprise an eighth computer program code for locking said first media content, rendering said second media content on said content display interface, and unlocking said first media content when said access condition is met, wherein said access condition is configured to define one or more of a plurality of engagement tasks with said second media content to be completed.
